(19) United States
(12) Patent Application Publication
(10) Pub. No.: US 2020/0369293 A1
(43) Pub. Date: Nov. 26, 2020

(54) AUTONOMOUS DRIVING APPARATUS AND METHOD

(71) Applicant: HYUNDAI MOBIS Co., Ltd., Seoul (KR)

(72) Inventors: Byeong Hwan JEON, Yongin-si (KR); Hyuk LEE, Yongin-si (KR); Soon Jong JIN, Yongin-si (KR); Jun Han LEE, Yongin-si (KR); Jeong Hee LEE, Yongin-si (KR); Yong Kwan JI, Yongin-si (KR)

(21) Appl. No.: 15/930,336

(22) Filed: May 12, 2020

(30) Foreign Application Priority Data
May 20, 2019 (KR) 10-2019-0058598
May 20, 2019 (KR) 10-2019-0058599
May 20, 2019 (KR) 10-2019-0058603
May 20, 2019 (KR) 10-2019-0058610
May 20, 2019 (KR) 10-2019-0058612

(51) Int. Cl. B60W 60/00; B60W 30/18; B60W 40/08; B60W 50/14; G05D 1/02

(52) U.S. Cl. CPC B60W 60/0016; B60W 30/18163; B60W 40/08; B60W 2540/229; G05D 1/0274; B60W 2040/0818; B60W 2540/221; B60W 50/14

(57) ABSTRACT

An autonomous driving apparatus and method, in which the autonomous driving apparatus may include a sensor unit configured to detect a surrounding vehicle around an ego vehicle that autonomously travels and a state of a driver who has got in the ego vehicle, a driving information detector configured to detect driving information on a driving state of the ego vehicle, a memory configured to store map information, and a processor configured to control autonomous driving of the ego vehicle based on the map information stored in the memory.

### CROSS-REFERENCE TO RELATED APPLICATIONS

This application claims priority from and the benefit of Korean Patent Application Nos. 10-2019-0058612, 10-2019-0058610, 10-2019-0058599, 10-2019-0058598, and 10-2019-0058603, filed on May 20, 2019, which are hereby incorporated by reference for all purposes as if set forth herein.

### BACKGROUND

### Field

Exemplary embodiments of the present invention relate to an autonomous driving apparatus and method applied to an autonomous vehicle.

### Discussion of the Background

Today's automobile industry is moving towards an implementation of autonomous driving to minimize the intervention of a driver in vehicle driving. An autonomous vehicle refers to a vehicle that autonomously determines a driving path by recognizing a surrounding environment using an external information detection and processing function upon driving and independently travels using its own motive power.

The autonomous vehicle can autonomously travel up to a destination while preventing a collision against an obstacle on a driving path and controlling a vehicle speed and driving direction based on a shape of a road although a driver does not manipulate a steering wheel, an acceleration pedal or a brake. For example, the autonomous vehicle may perform acceleration in a straight road, and may perform deceleration while changing a driving direction in accordance with the curvature of a curved road in the curved road.

In order to guarantee the safe driving of an autonomous vehicle, the driving of the autonomous vehicle needs to be controlled based on a measured driving environment by precisely measuring the driving environment using sensors mounted on the vehicle and continuing to monitor the driving state of the vehicle. To this end, various sensors such as a LIDAR sensor, a radar sensor, an ultrasonic sensor and a camera sensor, that is, sensors for detecting surrounding objects such as surrounding vehicles, pedestrians and fixed facilities, are applied to the autonomous vehicle. Data output by such a sensor is used to determine information on a driving environment, for example, state information such as a location, shape, moving direction and moving speed of a surrounding object.

Furthermore, the autonomous vehicle also has a function for optimally determining a driving path and driving lane by determining and correcting the location of the vehicle using previously stored map data, controlling the driving of the vehicle so that the vehicle does not deviate from the determined path and lane, and performing defense and evasion driving for a risk factor in a driving path or a vehicle that suddenly appears nearby.

Background of the Disclosure is disclosed in Korean Patent Application Laid-Open No. 10-1998-0068399 (Oct. 15, 1998).

The above information disclosed in this Background section is only for enhancement of understanding of the background of the invention and, therefore, it may contain information that does not constitute prior art.

### SUMMARY

A first exemplary embodiment of the present invention provides an autonomous driving apparatus and method which can improve the autonomous driving stability of a vehicle and also enables follow-up measures suitable for the state of a passenger in such a manner that the lateral driving of the vehicle is controlled at a tempo determined by taking into consideration the states of a driver and fellow passenger in a process in which the autonomous driving of the vehicle is controlled.

A second exemplary embodiment of the present invention provides an autonomous driving apparatus and method for improving the driving stability and driving accuracy of an autonomous vehicle by learning an autonomous driving algorithm applied to autonomous driving control by taking into consideration a driving manipulation involved by a passenger in an autonomous driving control process of an ego vehicle.

A third exemplary embodiment of the present invention provides an autonomous driving apparatus and method for securing the driving stability of an ego vehicle in a process of traveling based on a trajectory up to a target point when the target point at which the driving direction of the ego vehicle is changed, such as a crossroad or junction, is present in the autonomous driving path of the ego vehicle and for improving parking convenience of a passenger by controlling the autonomous parking of the ego vehicle so that the ego vehicle can reach a parking location into which the parking preference tendency of the passenger has been incorporated when the ego vehicle parks.

A fourth exemplary embodiment of the present invention provides an autonomous driving apparatus and method for improving the driving stability and driving accuracy of an autonomous vehicle by correcting the driving trajectory of an ego vehicle by taking into consideration a degree of risk based on a distance between the ego vehicle and a surrounding vehicle.

A fifth exemplary embodiment of the present invention provides an autonomous driving apparatus and method for improving the driving stability and driving accuracy of an autonomous vehicle by outputting a proper warning to a passenger based on the reliability of autonomous driving control performed on the autonomous vehicle.

In the first exemplary embodiment, an autonomous driving apparatus includes a sensor unit configured to detect a surrounding vehicle around an ego vehicle that autonomously travels and a state of a driver who has got in the ego vehicle, a driving information detector configured to detect driving information on a driving state of the ego vehicle, a memory configured to store map information, and a processor configured to control autonomous driving of the ego vehicle based on the map information stored in the memory. The memory stores a lane change pattern of the driver analyzed based on the driving information of the ego vehicle when the ego vehicle changes lanes, and a lane change rate determined based on information on a state of a road when the ego vehicle changes lanes and indicative of a tempo of the lane change of the ego vehicle. The processor is configured to control autonomous driving of the ego vehicle based on a first expected driving trajectory generated based on the map information and lane change rate stored in the memory and the driving information of the ego vehicle detected by the driving information detector and to control the autonomous driving of the ego vehicle by selectively applying the first expected driving trajectory and a second expected driving trajectory based on the state of the driver detected by the sensor unit. The second expected driving trajectory is generated by incorporating a corrected lane change rate corrected from the lane change rate stored in the memory.

The lane change rate may be mapped to an entrance steering angle and entrance speed for entering a target lane when the ego vehicle changes lanes and stored in the memory. The processor may be configured to control the autonomous driving of the ego vehicle based on the entrance steering angle and entrance speed mapped to the lane change rate, when controlling the autonomous driving of the ego vehicle based on the first expected driving trajectory.

The processor may be configured to control the autonomous driving of the ego vehicle based on an entrance steering angle and entrance speed having values greater than the entrance steering angle and entrance speed mapped to the lane change rate, when controlling the autonomous driving of the ego vehicle based on the second expected driving trajectory.

The the processor may be configured to control the autonomous driving of the ego vehicle based on the first expected driving trajectory, when a driving concentration level of the driver determined based on the state of the driver detected by the sensor unit is a preset critical concentration level or more, if a fellow passenger other than the driver has not got in the ego vehicle.

The processor may be configured to control the autonomous driving of the ego vehicle based on the second expected driving trajectory, when it is determined that an emergency situation has occurred in the driver, based on the state of the driver detected by the sensor unit, if a fellow passenger other than the driver has not got in the ego vehicle.

The processor may be configured to control the autonomous driving of the ego vehicle based on the second expected driving trajectory, when it is determined that an emergency situation has occurred in a fellow passenger based on a state of the fellow passenger detected by the sensor unit, if the fellow passenger in addition to the driver has got in the ego vehicle.

The autonomous driving apparatus may further include an output unit. The processor may be configured to output a warning through the output unit either when a driving concentration level of the driver of the ego vehicle is less than a preset critical concentration level or when it is determined that an emergency situation has occurred in the driver or fellow passenger of the ego vehicle.

In the first exemplary embodiment, an autonomous driving method includes a first control step of controlling, by a processor, autonomous driving of an ego vehicle based on a first expected driving trajectory generated based on map information and a lane change rate stored in a memory and driving information of the ego vehicle, wherein the lane change rate is determined based on a lane change pattern of a driver analyzed based on the driving information of the ego vehicle when the ego vehicle changes lanes and information on a state of a road when the ego vehicle changes lanes, and the lane change rate is indicative of a tempo of the lane change of the ego vehicle and stored in the memory, and a second control step of controlling, by the processor, the autonomous driving of the ego vehicle by selectively applying the first expected driving trajectory and a second expected driving trajectory based on a state of the driver detected by a sensor unit and getting in the ego vehicle, wherein the second expected driving trajectory is generated by incorporating a corrected lane change rate corrected from the lane change rate stored in the memory.

In the second exemplary embodiment, an autonomous driving apparatus includes a memory configured to store an autonomous driving algorithm for autonomous driving control over an ego vehicle and a processor configured to control autonomous driving of the ego vehicle based on the autonomous driving algorithm stored in the memory. The processor is configured to determine whether to update the autonomous driving algorithm, stored in the memory, by comparing the autonomous driving algorithm with a surrounding vehicle autonomous-driving algorithm received from a surrounding vehicle around the ego vehicle and to allow the learning of an autonomous driving algorithm now stored in the memory to be performed by taking into consideration a driving manipulation of a passenger of the ego vehicle involved in a process of controlling the autonomous driving of the ego vehicle based on the autonomous driving algorithm now stored in the memory through the update.

A first accuracy index indicative of autonomous driving control accuracy for the ego vehicle may be mapped to the autonomous driving algorithm. A second accuracy index indicative of autonomous driving control accuracy for the surrounding vehicle may be mapped to the surrounding vehicle autonomous-driving algorithm.

The processor may be configured to update the autonomous driving algorithm by storing the surrounding vehicle autonomous-driving algorithm in the memory when the second accuracy index mapped to the surrounding vehicle autonomous-driving algorithm is greater than the first accuracy index mapped to the autonomous driving algorithm.

The processor may be configured to determine whether a driving manipulation of the passenger has been involved in the process of controlling the autonomous driving of the ego vehicle based on the autonomous driving algorithm now stored in the memory and to allow the learning of the autonomous driving algorithm to be performed based on a result of a comparison between a control process according to the autonomous driving algorithm at timing at which the driving manipulation of the passenger is involved and the driving manipulation of the passenger, if it is determined that the driving manipulation of the passenger has been involved.

The processor may be configured to stop the autonomous driving control over the ego vehicle and then allow the learning of the autonomous driving algorithm to be performed, if it is determined that the driving manipulation of the passenger has been involved.

The processor may be configured to verify a degree of risk of the driving manipulation of the passenger and then allow the learning of the autonomous driving algorithm to be performed, when the control process and the driving manipulation of the passenger are different.

The autonomous driving apparatus may further include a sensor unit configured to detect a surrounding object around the ego vehicle and a driving information detector configured to detect driving information on a driving state of the ego vehicle. The processor may be configured to allow the learning of the autonomous driving algorithm to be performed based on information on the surrounding object detected by the sensor unit, the driving information of the ego vehicle detected by the driving information detector, the control process, and the driving manipulation of the passenger.

In the second exemplary embodiment, an autonomous driving method includes controlling, by a processor, autonomous driving of an ego vehicle based on an autonomous driving algorithm stored in a memory, determining, by the processor, whether to update the autonomous driving algorithm, stored in the memory, by comparing the autonomous driving algorithm with a surrounding vehicle autonomous-driving algorithm received from a surrounding vehicle around the ego vehicle, and allowing, by the processor, the learning of an autonomous driving algorithm, now stored in the memory, to be performed by taking into consideration a driving manipulation of a passenger of the ego vehicle involved in a process of controlling the autonomous driving of the ego vehicle based on the autonomous driving algorithm now stored in the memory through the update.

In the third exemplary embodiment, an autonomous driving apparatus includes a memory configured to store map information and a processor configured to control autonomous driving of an ego vehicle based on the map information stored in the memory. The processor is configured to generate an expected driving trajectory of the ego vehicle based on the map information stored in the memory, to modify, based on a distance from a current location of the ego vehicle to a target point at which the driving direction of the ego vehicle is changed, a target trajectory that belongs to the expected driving trajectory of the ego vehicle and that corresponds to a trajectory between the current location of the ego vehicle and the target point, so that the ego vehicle reaches the target point through a lane change, when the target point is present ahead of the ego vehicle in a process of controlling the autonomous driving of the ego vehicle based on the generated expected driving trajectory of the ego vehicle, and to control the autonomous driving of the ego vehicle so that the ego vehicle travels based on the modified target trajectory.

The autonomous driving apparatus may further include a sensor unit configured to detect a surrounding vehicle around the ego vehicle. The processor may be configured to generate an expected driving trajectory and actual driving trajectory of the surrounding vehicle based on the map information stored in the memory and driving information of the surrounding vehicle the detected by the sensor unit, to update the map information, stored in the memory, with new map information received from a server, when a trajectory error between the expected driving trajectory and actual driving trajectory of the surrounding vehicle is a preset critical value or more, and to generate an expected driving trajectory of the ego vehicle based on the updated map information.

The processor may be configured to modify the target trajectory when a lateral distance and a longitudinal distance between the current location of the ego vehicle and the target point are a preset first critical distance or more and a preset second critical distance or more, respectively.

The processor may be configured to modify the target trajectory based on the lateral distance and longitudinal distance between the current location of the ego vehicle and the target point, so that the ego vehicle reaches the target point as a step-by-step lane change of the ego vehicle is performed with respect to a lane present between the current location of the ego vehicle and the target point.

The processor may be configured to modify the target trajectory using a method of determining a first longitudinal traveling distance in which the ego vehicle travels and a second longitudinal traveling distance in which the ego vehicle travels in a changed lane, in a process in which the ego vehicle completes the lane change after initiating the lane change to a neighbor lane based on the lateral distance and longitudinal distance between the current location of the ego vehicle and the target point.

The processor may be configured to generate a parking trajectory, on which the ego vehicle reaches a parking location into which parking preference of a passenger of the ego vehicle has been incorporated, based on parking map information on a parking space when the ego vehicle reaches a destination and parks and to perform autonomous parking of the ego vehicle based on the generated parking trajectory.

The processor may be is configured to receive a parking trajectory of a vehicle ahead entering the parking space when the vehicle ahead is present, to generate a parking trajectory and parking location of the ego vehicle so that the parking trajectory and parking location of the ego vehicle do not overlap the parking trajectory and parking location of the vehicle ahead, and to perform autonomous parking of the ego vehicle.

The processor may be configured to transmit the parking trajectory of the ego vehicle to a vehicle behind entering the parking space so that the parking trajectory and parking location of the ego vehicle do not overlap a parking trajectory and parking location of the vehicle behind, when the vehicle behind is present.

In the third exemplary embodiment, an autonomous driving method includes a first control step of controlling, by a processor, autonomous driving of an ego vehicle based on an expected driving trajectory of the ego vehicle generated based on map information stored in a memory, a step of determining, by the processor, whether a target point at which the driving direction of the ego vehicle is changed is present ahead of the ego vehicle, a step of modifying, by the processor, a target trajectory that belongs to the expected driving trajectory of the ego vehicle and that corresponds to a trajectory between a current location of the ego vehicle and the target point, based on a distance from the current location of the ego vehicle to the target point, so that the ego vehicle reaches the target point through a lane change, if it is determined that the target point is present ahead of the ego vehicle, and a second control step of controlling, by the processor, the autonomous driving of the ego vehicle so that the ego vehicle travels based on the modified target trajectory.

In the fourth exemplary embodiment, an autonomous driving apparatus includes a sensor unit configured to detect a surrounding vehicle around an ego vehicle that autonomously travels, a memory configured to store map information, and a processor configured to control autonomous driving of the ego vehicle based on the map information stored in the memory. The processor is configured to generate an actual driving trajectory of the surrounding vehicle based on driving information of the surrounding vehicle detected by the sensor unit, to generate an expected driving trajectory of the surrounding vehicle based on the map information stored in the memory, to generate an expected driving trajectory of the ego vehicle based on the map information stored in the memory, and to correct the expected driving trajectory of the ego vehicle based on a degree of risk according to a distance from the ego vehicle to a target surrounding vehicle, if it is determined that the expected driving trajectory of the ego vehicle needs to be corrected, based on a comparison between the actual driving trajectory and expected driving trajectory of the surrounding vehicle.

The processor may be configured to determine that the expected driving trajectory of the ego vehicle needs to be corrected, when a trajectory error between the actual driving trajectory and expected driving trajectory of the surrounding vehicle is a preset critical value or more.

The target surrounding vehicle may include first and second target surrounding vehicles travelling on the left and right sides of the ego vehicle, respectively. The processor may be configured to correct the expected driving trajectory of the ego vehicle in the direction in which a degree of driving risk of the ego vehicle is low, based on a lateral distance between the ego vehicle and the first target surrounding vehicle and a lateral distance between the ego vehicle and the second target surrounding vehicle.

The processor may be configured to determine a primary shift value for correcting the expected driving trajectory of the ego vehicle in the direction in which the degree of driving risk of the ego vehicle is low, to determine the final shift value by correcting the primary shift value based on a weight indicative of a degree of risk of approach, when the ego vehicle approaches the first and second target surrounding vehicles, and to correct the expected driving trajectory of the ego vehicle based on the determined final shift value.

In the fourth exemplary embodiment, an autonomous driving method includes controlling, by a processor, autonomous driving of an ego vehicle based on map information stored in a memory, generating, by the processor, an actual driving trajectory of a surrounding vehicle around the ego vehicle based on driving information of the surrounding vehicle detected by a sensor unit, generating, by the processor, an expected driving trajectory of the surrounding vehicle based on the map information stored in the memory, generating, by the processor, an expected driving trajectory of the ego vehicle based on the map information stored in the memory, determining, by the processor, whether the expected driving trajectory of the ego vehicle needs to be corrected, based on a comparison between the actual driving trajectory and expected driving trajectory of the surrounding vehicle, and correcting, by the processor, the expected driving trajectory of the ego vehicle based on a degree of risk according to a distance from the ego vehicle to a target surrounding vehicle, if it is determined that the expected driving trajectory of the ego vehicle needs to be corrected.

In the fifth exemplary embodiment, an autonomous driving apparatus includes a sensor unit configured to detect a surrounding vehicle around an ego vehicle that autonomously travels and a state of a passenger who has got in the ego vehicle, an output unit, a memory configured to store map information, and a processor configured to control autonomous driving of the ego vehicle based on the map information stored in the memory. The processor is configured to generate an actual driving trajectory of the surrounding vehicle based on driving information of the surrounding vehicle detected by the sensor unit, to generate an expected driving trajectory of the surrounding vehicle based on the map information stored in the memory, to perform the diagnosis of reliability of autonomous driving control over the ego vehicle based on the size of a trajectory error between the generated actual driving trajectory and expected driving trajectory or a cumulative addition of the trajectory errors, and to output a warning to the passenger through the output unit by taking into consideration the state of the passenger detected by the sensor unit, if it is determined that autonomous driving control over the ego vehicle is unreliable, based on a result of the execution of the diagnosis of reliability.

The processor may be configured to determine that the autonomous driving control over the ego vehicle is unreliable, when the state in which the size of the trajectory error is a preset first critical value or more occurs within a preset first critical time.

The processor may be configured to additionally perform the diagnosis of reliability based on the cumulative addition of the trajectory errors in the state in which the size of the trajectory error less than the first critical value is maintained during the first critical time.

The processor may be configured to determine that the autonomous driving control over the ego vehicle is unreliable, when the state in which the cumulative addition of the trajectory errors is a preset second critical value or more occurs within a second critical time preset as a value greater than the first critical time in the state in which the size of the trajectory error less than the first critical value is maintained during the first critical time.

The processor may be configured to release the warning output through the output unit when the size of the trajectory error becomes less than the first critical value or the cumulative addition of the trajectory errors becomes less than the second critical value after outputting the warning to the passenger through the output unit.

The processor may be configured to release the warning output through the output unit, if it is determined that the state of the passenger detected by the sensor unit is a forward looking state, after outputting the warning to the passenger through the output unit.

In the fifth exemplary embodiment, an autonomous driving method includes controlling, by a processor, autonomous driving of an ego vehicle based on map information stored in a memory, generating, by the processor, an actual driving trajectory of a surrounding vehicle around the ego vehicle based on driving information of the surrounding vehicle detected by a sensor unit, generating, by the processor, an expected driving trajectory of the surrounding vehicle based on the map information stored in the memory, performing, by the processor, the diagnosis of reliability of autonomous driving control over the ego vehicle based on the size of a trajectory error between the generated actual driving trajectory and expected driving trajectory or a cumulative addition of the trajectory errors, and outputting, by the processor, a warning to a passenger through an output unit by taking into consideration a state of the passenger detected by the sensor unit, if it is determined that the autonomous driving control over the ego vehicle is unreliable, based on a result of the execution of the diagnosis of reliability.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a general block diagram of an autonomous driving control system to which an autonomous driving apparatus according to an exemplary embodiment of the present invention may be applied.

FIG. 2 is a block diagram illustrating a detailed configuration of an autonomous driving integrated controller in the autonomous driving apparatus according to an exemplary embodiment of the present invention.

FIG. 3 is an exemplary diagram illustrating an example in which the autonomous driving apparatus according to an exemplary embodiment of the present invention is applied to a vehicle.

FIG. 4 is an exemplary diagram illustrating an example of an internal structure of a vehicle to which the autonomous driving apparatus according to an exemplary embodiment of the present invention is applied.

FIG. 5 is an exemplary diagram illustrating an example of a set distance and horizontal field of view within which a LIDAR sensor, a radar sensor and a camera sensor may detect a surrounding object in the autonomous driving apparatus according to an exemplary embodiment of the present invention.

FIG. 6 is an exemplary diagram illustrating an example in which a sensor unit detects a surrounding vehicle in the autonomous driving apparatus according to an exemplary embodiment of the present invention.

FIG. 7 is a block diagram illustrating a process of a lane change rate being databased and stored in the memory in an autonomous driving apparatus according to a first exemplary embodiment of the present invention.

FIGS. 8 and 9 are flowcharts for describing an autonomous driving method according to the first exemplary embodiment of the present invention.

FIG. 10 is a flowchart for describing an autonomous driving method according to a second exemplary embodiment of the present invention.

FIG. 11 is an exemplary diagram illustrating a lateral distance and longitudinal distance between a current location and target point of an ego vehicle in an autonomous driving apparatus according to a third exemplary embodiment of the present invention.

FIG. 12 is an exemplary diagram illustrating a process of a target trajectory being modified in the autonomous driving apparatus according to the third exemplary embodiment of the present invention.

FIG. 13 is a flowchart for describing an autonomous driving method according to the third exemplary embodiment of the present invention.

FIGS. 14 and 15 are flowcharts for describing an autonomous driving method according to a fourth exemplary embodiment of the present invention.

FIGS. 16 and 17 are flowcharts for describing an autonomous driving method according to a fifth exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Hereinafter, an autonomous driving apparatus and method will be described below with reference to the accompanying drawings through various exemplary embodiments. The thickness of lines or the size of elements shown in the drawings in this process may have been exaggerated for the clarity of a description and for convenience' sake. Terms to be described below have been defined by taking into consideration their functions in the disclosure, and may be changed depending on a user or operator's intention or practice. Accordingly, such terms should be interpreted based on the overall contents of this specification.

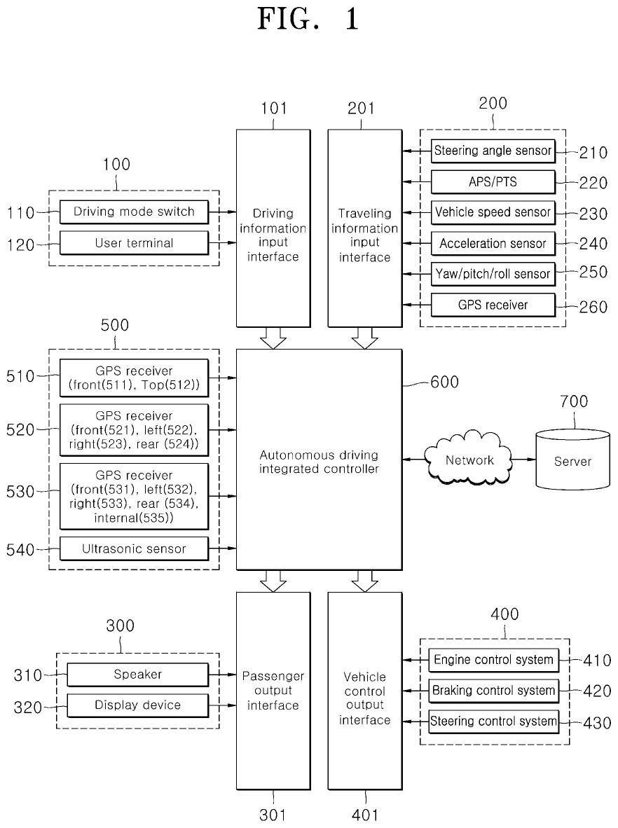

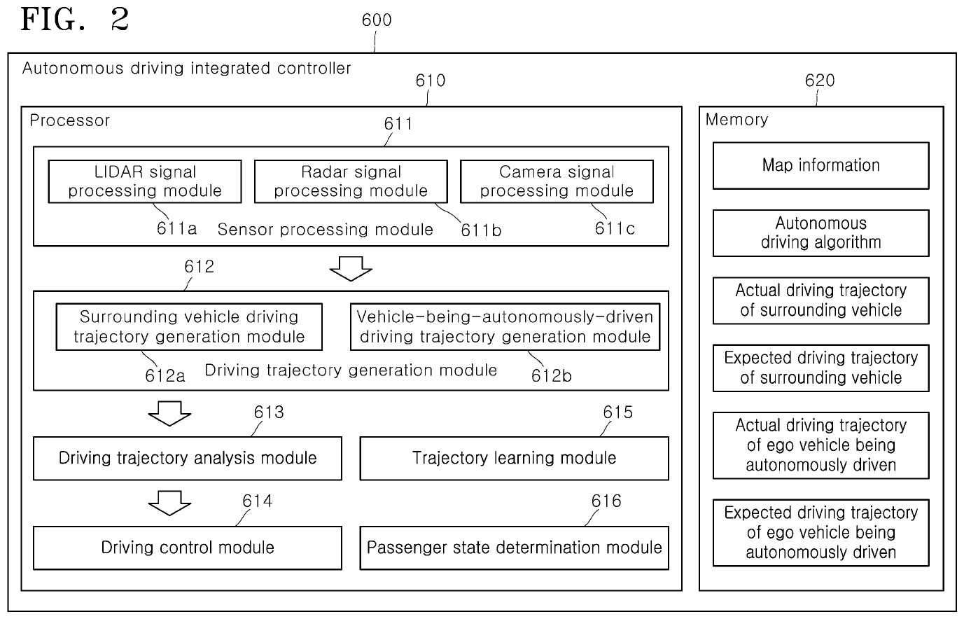

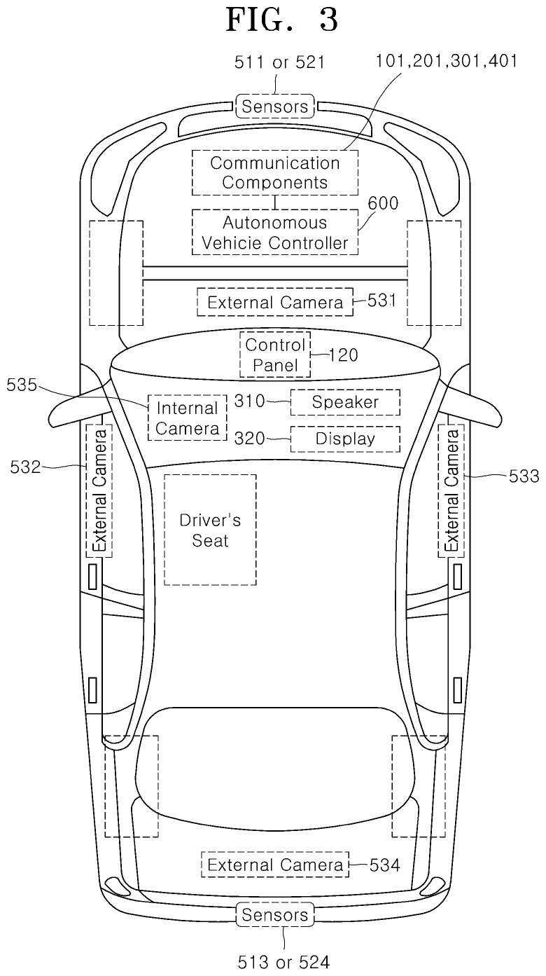

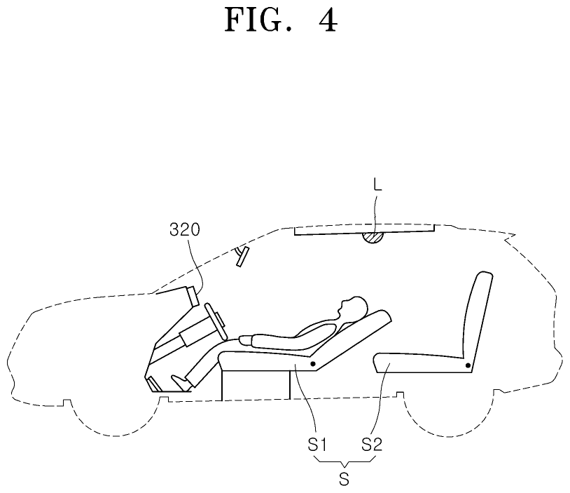

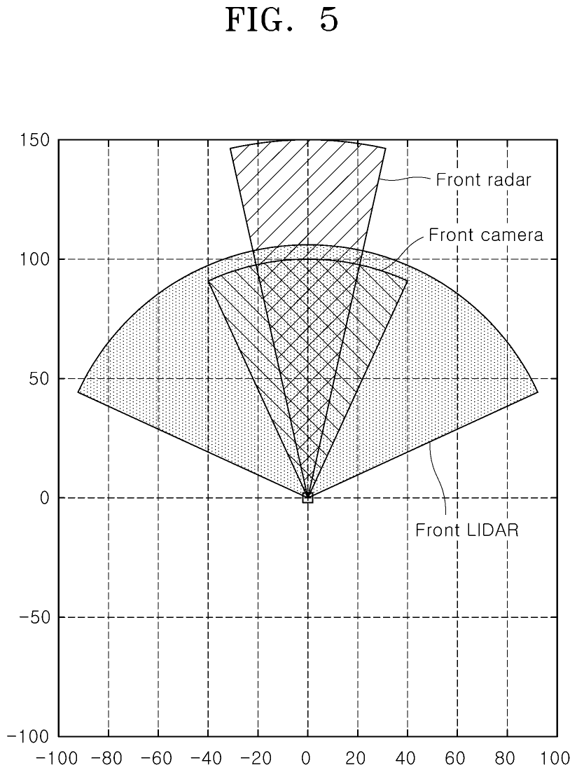

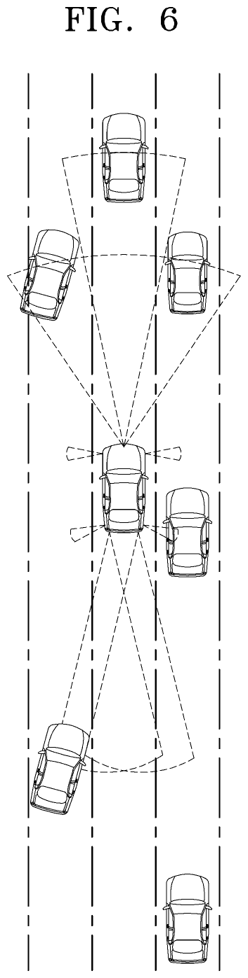

FIG. 1 is a general block diagram of an autonomous driving control system to which an autonomous driving apparatus according to an exemplary embodiment of the present invention may be applied. FIG. 2 is a block diagram illustrating a detailed configuration of an autonomous driving integrated controller in the autonomous driving apparatus according to an exemplary embodiment of the present invention. FIG. 3 is an exemplary diagram illustrating an example in which the autonomous driving apparatus according to an exemplary embodiment of the present invention is applied to a vehicle. FIG. 4 is an exemplary diagram illustrating an example of an internal structure of a vehicle to which the autonomous driving apparatus according to an exemplary embodiment of the present invention. FIG. 5 is an exemplary diagram illustrating an example of a set distance and horizontal field of view within which a LIDAR sensor, a radar sensor and a camera sensor may detect a surrounding object in the autonomous driving apparatus according to an exemplary embodiment of the present invention. FIG. 6 is an exemplary diagram illustrating an example in which a sensor unit detects a surrounding vehicle in the autonomous driving apparatus according to an exemplary embodiment of the present invention.

First, the structure and functions of an autonomous driving control system to which an autonomous driving apparatus according to the present exemplary embodiment may be applied are described with reference to FIGS. 1 and 3. As illustrated in FIG. 1, the autonomous driving control system may be implemented based on an autonomous driving integrated controller 600 configured to transmit and receive data necessary for autonomous driving control of a vehicle through a driving information input interface 101, a traveling information input interface 201, a passenger output interface 301 and a vehicle control output interface 401.

The autonomous driving integrated controller 600 may obtain, through the driving information input interface 101, driving information based on a manipulation of a passenger for a user input unit 100 in an autonomous driving mode or manual driving mode of a vehicle. As illustrated in FIG. 1, the user input unit 100 may include a driving mode switch 110 and a user terminal 120 (e.g., a navigation terminal mounted on a vehicle or a smartphone or tablet PC owned by a passenger), for example. Accordingly, driving information may include driving mode information and navigation information of a vehicle. For example, a driving mode (i.e., an autonomous driving mode/manual driving mode or a sport mode/eco mode/safe mode/normal mode) of a vehicle determined by a manipulation of a passenger for the driving mode switch 110 may be transmitted to the autonomous driving integrated controller 600 through the driving information input interface 101 as the driving information. Furthermore, navigation information, such as the destination of a passenger and a path up to the destination (e.g., the shortest path or preference path, selected by the passenger, among candidate paths up to the destination) input by a passenger through the user terminal 120, may be transmitted to the autonomous driving integrated controller 600 through the driving information input interface 101 as the driving information. The user terminal 120 may be implemented as a control panel (e.g., touch screen panel) that provides a user interface (UI) through which a driver inputs or modifies information for autonomous driving control of a vehicle. In this case, the driving mode switch 110 may be implemented as a touch button on the user terminal 120.

Furthermore, the autonomous driving integrated controller 600 may obtain traveling information indicative of a driving state of a vehicle through the traveling information input interface 201. The traveling information may include a steering angle formed when a passenger manipulates a steering wheel, an acceleration pedal stroke or brake pedal stroke formed when an acceleration pedal or brake pedal is stepped on, and various types of information indicative of driving states and behaviors of a vehicle, such as a vehicle speed, acceleration, a yaw, a pitch and a roll, that is, behaviors formed in the vehicle. The pieces of traveling information may be detected by a traveling information detection unit 200, including a steering angle sensor 210, an accel position sensor (APS)/pedal travel sensor (PTS) 220, a vehicle speed sensor 230, an acceleration sensor 240, and a yaw/pitch/roll sensor 250, as illustrated in FIG. 1. Furthermore, the traveling information of a vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201, and may be used to control the driving of a vehicle in the autonomous driving mode or manual driving mode of the vehicle.

Furthermore, the autonomous driving integrated controller 600 may transmit, to an output unit 300, driving state information, provided to a passenger, through the passenger output interface 301 in the autonomous driving mode or manual driving mode of a vehicle. That is, the autonomous driving integrated controller 600 transmits driving state information of a vehicle to the output unit 300 so that a passenger can check the autonomous driving state or manual driving state of the vehicle based on the driving state information output through the output unit 300. The driving state information may include various types of information indicative of driving states of a vehicle, such as a current driving mode, transmission range and vehicle speed of the vehicle, for example. Furthermore, if it is determined that it is necessary to warn a driver in the autonomous driving mode or manual driving mode of a vehicle along with the driving state information, the autonomous driving integrated controller 600 transmits warning information to the output unit 300 through the passenger output interface 301 so that the output unit 300 can output a warning to the driver. In order to output such driving state information and warning information acoustically and visually, the output unit 300 may include a speaker 310 and a display 320 as illustrated in FIG. 1. In this case, the display 320 may be implemented as the same device as the user terminal 120 or may be implemented as an independent device separated from the user terminal 120.

Furthermore, the autonomous driving integrated controller 600 may transmit control information for driving control of a vehicle to a low-ranking control system 400, applied to a vehicle, through the vehicle control output interface 401 in the autonomous driving mode or manual driving mode of the vehicle. As illustrated in FIG. 1, the low-ranking control system 400 for driving control of a vehicle may include an engine control system 410, a braking control system 420 and a steering control system 430. The autonomous driving integrated controller 600 may transmit engine control information, braking control information and steering control information, as the control information, to the respective low-ranking control systems 410, 420 and 430 through the vehicle control output interface 401. Accordingly, the engine control system 410 may control the vehicle speed and acceleration of a vehicle by increasing or decreasing fuel supplied to an engine. The braking control system 420 may control the braking of the vehicle by controlling braking power of the vehicle. The steering control system 430 may control the steering of the vehicle through a steering apparatus (e.g., motor driven power steering (MDPS) system) applied to the vehicle.

As described above, the autonomous driving integrated controller 600 according to the present exemplary embodiment may obtain driving information based on a manipulation of a driver and traveling information indicative of a driving state of a vehicle through the driving information input interface 101 and the traveling information input interface 201, respectively, may transmit, to the output unit 300, driving state information and warning information, generated based on an autonomous driving algorithm processed by a processor 610 therein, through the passenger output interface 301, and may transmit, to the low-ranking control system 400, control information, generated based on the autonomous driving algorithm processed by the processor 610, through the vehicle control output interface 401 so that driving control of the vehicle is performed.

In order to guarantee stable autonomous driving of a vehicle, it is necessary to continuously monitor a driving state of the vehicle by accurately measuring a driving environment of the vehicle and to control driving based on the measured driving environment. To this end, as illustrated in FIG. 1, the autonomous driving apparatus according to the present exemplary embodiment may include a sensor unit 500 for detecting a surrounding object of a vehicle, such as a surrounding vehicle, pedestrian, road or fixed facility (e.g., a signal light, a signpost, a traffic sign or a construction fence). The sensor unit 500 may include one or more of a LIDAR sensor 510, a radar sensor 520 and a camera sensor 530 in order to detect a surrounding object outside a vehicle, as illustrated in FIG. 1.

The LIDAR sensor 510 may transmit a laser signal to the periphery of a vehicle, and may detect a surrounding object outside the vehicle by receiving a signal reflected and returned from a corresponding object. The LIDAR sensor 510 may detect a surrounding object located within a set distance, set vertical field of view and set horizontal field of view, which are predefined depending on its specifications. The LIDAR sensor 510 may include a front LIDAR sensor 511, a top LIDAR sensor 512 and a rear LIDAR sensor 513 installed at the front, top and rear of a vehicle, respectively, but the installation location of each sensor and the number of sensors installed are not limited to a specific embodiment. A threshold for determining the validity of a laser signal reflected and returned from a corresponding object may be previously stored in a memory 620 of the autonomous driving integrated controller 600. The processor 610 of the autonomous driving integrated controller 600 may determine a location (including a distance to a corresponding object), speed and moving direction of the corresponding object using a method of measuring the time taken for a laser signal, transmitted through the LIDAR sensor 510, to be reflected and returned from the corresponding object.

The radar sensor 520 may radiate electromagnetic waves around a vehicle, and may detect a surrounding object outside the vehicle by receiving a signal reflected and returned from a corresponding object. The radar sensor 520 may detect a surrounding object within a set distance, set vertical field of view and set horizontal field of view, which are predefined depending on its specifications. The radar sensor 520 may include a front radar sensor 521, a left radar sensor 522, a right radar sensor 523 and a rear radar sensor 524 installed at the front, left, right and rear of a vehicle, respectively, but the installation location of each sensor and the number of sensors installed are not limited to a specific embodiment. The processor 610 of the autonomous driving integrated controller 600 may determine a location (including a distance to a corresponding object), speed and moving direction of the corresponding object using a method of analyzing power of electromagnetic waves transmitted and received through the radar sensor 520.

The camera sensor 530 may detect a surrounding object outside a vehicle by photographing the periphery of the vehicle, and may detect a surrounding object within a set distance, set vertical field of view and set horizontal field of view, which are predefined depending on its specifications. The camera sensor 530 may include a front camera sensor 531, a left camera sensor 532, a right camera sensor 533 and a rear camera sensor 534 installed at the front, left, right and rear of a vehicle, respectively, but the installation location of each sensor and the number of sensors installed are not limited to a specific embodiment. The processor 610 of the autonomous driving integrated controller 600 may determine a location (including a distance to a corresponding object), speed and moving direction of the corresponding object by applying predefined image processing to an image captured by the camera sensor 530. Furthermore, an internal camera sensor 535 for photographing the inside of a vehicle may be mounted at a given location (e.g., rear view mirror) within the vehicle. The processor 610 of the autonomous driving integrated controller 600 may monitor a behavior and state of a passenger based on an image captured by the internal camera sensor 535, and may output guidance or a warning to the passenger through the output unit 300.

As illustrated in FIG. 1, the sensor unit 500 may further include an ultrasonic sensor 540 in addition to the LIDAR sensor 510, the radar sensor 520 and the camera sensor 530, and may further adopt various types of sensors for detecting a surrounding object of a vehicle along with the sensors. FIG. 3 illustrates an example in which in order to help understanding of the present exemplary embodiment, the front LIDAR sensor 511 or the front radar sensor 521 has been installed at the front of a vehicle, the rear LIDAR sensor 513 or the rear radar sensor 524 has been installed at the rear of the vehicle, and the front camera sensor 531, the left camera sensor 532, the right camera sensor 533 and the rear camera sensor 534 have been installed at the front, left, right and rear of the vehicle, respectively. However, as described above, the installation location of each sensor and the number of sensors installed are not limited to a specific embodiment. FIG. 5 illustrates an example of a set distance and horizontal field of view within which the LIDAR sensor 510, the radar sensor 520 and the camera sensor 530 may detect a surrounding object ahead of the vehicle. FIG. 6 illustrates an example in which each sensor detects a surrounding object. FIG. 6 is merely an example of the detection of a surrounding object. A method of detecting a surrounding object is determined by the installation location of each sensor and the number of sensors installed. A surrounding vehicle and a surrounding object in the omni-directional area of an ego vehicle that autonomously travels may be detected depending on a configuration of the sensor unit 500.

Furthermore, in order to determine a state of a passenger within a vehicle, the sensor unit 500 may further include a microphone and bio sensor for detecting a voice and bio signal (e.g., heart rate, electrocardiogram, respiration, blood pressure, body temperature, electroencephalogram, hotoplethysmography (or pulse wave) and blood sugar) of the passenger. The bio sensor may include a heart rate sensor, an electrocardiogram sensor, a respiration sensor, a blood pressure sensor, a body temperature sensor, an electroencephalogram sensor, a photoplethysmography sensor and a blood sugar sensor.

FIG. 4 illustrates an example of an internal structure of a vehicle. An internal device whose state is controlled by a manipulation of a passenger, such as a driver or fellow passenger of a vehicle, and which supports driving or convenience (e.g., rest or entertainment activities) of the passenger may be installed within the vehicle. Such an internal device may include a vehicle seat S in which a passenger is seated, a lighting device L such as an internal light and a mood lamp, the user terminal 120, the display 320, and an internal table. The state of the internal device may be controlled by the processor 610.

The angle of the vehicle seat S may be adjusted by the processor 610 (or by a manual manipulation of a passenger). If the vehicle seat S is configured with a front row seat S1 and a back row seat S2, only the angle of the front row seat S1 may be adjusted. If the back row seat S2 is not provided and the front row seat S1 is divided into a seat structure and a footstool structure, the front row seat S1 may be implemented so that the seat structure of the front row seat S1 is physically separated from the footstool structure and the angle of the front row seat S1 is adjusted. Furthermore, an actuator (e.g., motor) for adjusting the angle of the vehicle seat S may be provided. The on and off of the lighting device L may be controlled by the processor 610 (or by a manual manipulation of a passenger). If the lighting device L includes a plurality of lighting units such as an internal light and a mood lamp, the on and off of each of the lighting units may be independently controlled. The angle of the user terminal 120 or the display 320 may be adjusted by the processor 610 (or by a manual manipulation of a passenger) based on an angle of field of a passenger. For example, the angle of the user terminal 120 or the display 320 may be adjusted so that a screen thereof is placed in a passenger's gaze direction. In this case, an actuator (e.g., motor) for adjusting the angle of the user terminal 120 and the display 320 may be provided.

As illustrated in FIG. 1, the autonomous driving integrated controller 600 may communicate with a server 700 over a network. Various communication methods, such as a wide area network (WAN), a local area network (LAN) or a personal area network (PAN), may be adopted as a network method between the autonomous driving integrated controller 600 and the server 700. Furthermore, in order to secure wide network coverage, a low power wide area network (LPWAN, including commercialized technologies such as LoRa, Sigfox, Ingenu, LTE-M and NB-IOT, that is, networks having very wide coverage, among the IoT) communication method may be adopted. For example, a LoRa (capable of low power communication and also having wide coverage of a maximum of about 20 Km) or Sigfox (having coverage of 10 Km (downtown) to 30 Km (in the outskirt area outside the downtown area) according to environments) communication method may be adopted. Furthermore, LTE network technologies based on 3^{rd} generation partnership project (3GPP) Release 12, 13, such as machine-type communications (LTE-MTC) (or LTE-M), narrowband (NB) LTE-M, and NB IoT having a power saving mode (PSM), may be adopted. The server 700 may provide the latest map information (may correspond to various types of map information, such as two-dimensional (2-D) navigation map data, three-dimensional (3-D) manifold map data or 3-D high-precision electronic map data). Furthermore, the server 700 may provide various types of information, such as accident information, road control information, traffic volume information and weather information in a road. The autonomous driving integrated controller 600 may update map information, stored in the memory 620, by receiving the latest map information from the server 700, may receive accident information, road control information, traffic volume information and weather information, and may use the information for autonomous driving control of a vehicle.

The structure and functions of the autonomous driving integrated controller 600 according to the present exemplary embodiment are described with reference to FIG. 2. As illustrated in FIG. 2, the autonomous driving integrated controller 600 may include the processor 610 and the memory 620.

The memory 620 may store basic information necessary for autonomous driving control of a vehicle or may store information generated in an autonomous driving process of a vehicle controlled by the processor 610. The processor 610 may access (or read) information stored in the memory 620, and may control autonomous driving of a vehicle. The memory 620 may be implemented as a computer-readable recording medium, and may operate in such a way to be accessed by the processor 610. Specifically, the memory 620 may be implemented as a hard drive, a magnetic tape, a memory card, a read-only memory (ROM), a random access memory (RAM), a digital video disc (DVD) or an optical data storage, such as an optical disk.

The memory 620 may store map information that is required for autonomous driving control by the processor 610. The map information stored in the memory 620 may be a navigation map (or a digital map) that provides information of a road unit, but may be implemented as a precise road map that provides road information of a lane unit, that is, 3-D high-precision electronic map data, in order to improve the precision of autonomous driving control. Accordingly, the map information stored in the memory 620 may provide dynamic and static information necessary for autonomous driving control of a vehicle, such as a lane, the center line of a lane, an enforcement lane, a road boundary, the center line of a road, a traffic sign, a road mark, the shape and height of a road, and a lane width.

Furthermore, the memory 620 may store the autonomous driving algorithm for autonomous driving control of a vehicle. The autonomous driving algorithm is an algorithm (recognition, determination and control algorithm) for recognizing the periphery of an autonomous vehicle, determining the state of the periphery thereof, and controlling the driving of the vehicle based on a result of the determination. The processor 610 may perform active autonomous driving control for a surrounding environment of a vehicle by executing the autonomous driving algorithm stored in the memory 620.

The processor 610 may control autonomous driving of a vehicle based on the driving information and the traveling information received from the driving information input interface 101 and the traveling information input interface 201, respectively, the information on a surrounding object detected by the sensor unit 500, and the map information and the autonomous driving algorithm stored in the memory 620. The processor 610 may be implemented as an embedded processor, such as a complex instruction set computer (CICS) or a reduced instruction set computer (RISC), or a dedicated semiconductor circuit, such as an application-specific integrated circuit (ASIC).

In the present exemplary embodiment, the processor 610 may control autonomous driving of an ego vehicle that autonomously travels by analyzing the driving trajectory of each of the ego vehicle that autonomously travels and a surrounding vehicle. To this end, the processor 610 may include a sensor processing module 611, a driving trajectory generation module 612, a driving trajectory analysis module 613, a driving control module 614, a passenger state determination module 616 and a trajectory learning module 615, as illustrated in FIG. 2. FIG. 2 illustrates each of the modules as an independent block based on its function, but the modules may be integrated into a single module and implemented as an element for integrating and performing the functions of the modules.

The sensor processing module 611 may determine traveling information of a surrounding vehicle (i.e., includes the location of the surrounding vehicle, and may further include the speed and moving direction of the surrounding vehicle along the location) based on a result of detecting, by the sensor unit 500, the surrounding vehicle around an ego vehicle that autonomously travels. That is, the sensor processing module 611 may determine the location of a surrounding vehicle based on a signal received through the LIDAR sensor 510, may determine the location of a surrounding vehicle based on a signal received through the radar sensor 520, may determine the location of a surrounding vehicle based on an image captured by the camera sensor 530, and may determine the location of a surrounding vehicle based on a signal received through the ultrasonic sensor 540. To this end, as illustrated in FIG. 1, the sensor processing module 611 may include a LIDAR signal processing module 611a, a radar signal processing module 611b and a camera signal processing module 611c. In some embodiments, an ultrasonic signal processing module (not illustrated) may be further added to the sensor processing module 611. An implementation method of the method of determining the location of a surrounding vehicle using the LIDAR sensor 510, the radar sensor 520 and the camera sensor 530 is not limited to a specific embodiment. Furthermore, the sensor processing module 611 may determine attribute information, such as the size and type of a surrounding vehicle, in addition to the location, speed and moving direction of the surrounding vehicle. An algorithm for determining information, such as the location, speed, moving direction, size and type of a surrounding vehicle, may be predefined.

The driving trajectory generation module 612 may generate an actual driving trajectory and expected driving trajectory of a surrounding vehicle and an actual driving trajectory of an ego vehicle that autonomously travels. To this end, as illustrated in FIG. 2, the driving trajectory generation module 612 may include a surrounding vehicle driving trajectory generation module 612a and a vehicle-being-autonomously-driven driving trajectory generation module 612b.

First, the surrounding vehicle driving trajectory generation module 612a may generate an actual driving trajectory of a surrounding vehicle.

Specifically, the surrounding vehicle driving trajectory generation module 612a may generate an actual driving trajectory of a surrounding vehicle based on traveling information of the surrounding vehicle detected by the sensor unit 500 (i.e., the location of the surrounding vehicle determined by the sensor processing module 611). In this case, in order to generate the actual driving trajectory of the surrounding vehicle, the surrounding vehicle driving trajectory generation module 612a may refer to map information stored in the memory 620, and may generate the actual driving trajectory of the surrounding vehicle by making cross reference to the location of the surrounding vehicle detected by the sensor unit 500 and a given location in the map information stored in the memory 620. For example, when a surrounding vehicle is detected at a specific point by the sensor unit 500, the surrounding vehicle driving trajectory generation module 612a may specify a currently detected location of the surrounding vehicle in map information stored in the memory 620 by making cross reference to the detected location of the surrounding vehicle and a given location in the map information. The surrounding vehicle driving trajectory generation module 612a may generate an actual driving trajectory of a surrounding vehicle by continuously monitoring the location of the surrounding vehicle as described above. That is, the surrounding vehicle driving trajectory generation module 612a may generate an actual driving trajectory of a surrounding vehicle by mapping the location of the surrounding vehicle, detected by the sensor unit 500, to a location in map information, stored in the memory 620, based on the cross reference and accumulating the location.

An actual driving trajectory of a surrounding vehicle may be compared with an expected driving trajectory of the surrounding vehicle to be described later to be used to determine whether map information stored in the memory 620 is accurate. In this case, if an actual driving trajectory of a specific surrounding vehicle is compared with an expected driving trajectory, there may be a problem in that it is erroneously determined that map information stored in the memory 620 is inaccurate although the map information is accurate. For example, if actual driving trajectories and expected driving trajectories of multiple surrounding vehicles are the same and an actual driving trajectory and expected driving trajectory of a specific surrounding vehicle are different, when only the actual driving trajectory of the specific surrounding vehicle is compared with the expected driving trajectory, it may be erroneously determined that map information stored in the memory 620 is inaccurate although the map information is accurate. In order to prevent this problem, it is necessary to determine whether the tendency of actual driving trajectories of a plurality of surrounding vehicles gets out of an expected driving trajectory. To this end, the surrounding vehicle driving trajectory generation module 612a may generate the actual driving trajectory of each of the plurality of surrounding vehicles. Furthermore, if it is considered that a driver of a surrounding vehicle tends to slightly move a steering wheel left and right during his or her driving process for the purpose of straight-line path driving, an actual driving trajectory of the surrounding vehicle may be generated in a curved form, not a straight-line form. In order to compute an error between expected driving trajectories to be described later, the surrounding vehicle driving trajectory generation module 612a may generate an actual driving trajectory of a straight-line form by applying a given smoothing scheme to the original actual driving trajectory generated in a curved form. Various schemes, such as interpolation for each location of a surrounding vehicle, may be adopted as the smoothing scheme.

Furthermore, the surrounding vehicle driving trajectory generation module 612a may generate an expected driving trajectory of a surrounding vehicle based on map information stored in the memory 620.

As described above, the map information stored in the memory 620 may be 3-D high-precision electronic map data. Accordingly, the map information may provide dynamic and static information necessary for autonomous driving control of a vehicle, such as a lane, the center line of a lane, an enforcement lane, a road boundary, the center line of a road, a traffic sign, a road mark, a shape and height of a road, and a lane width. If it is considered that a vehicle commonly travels in the middle of a lane, it may be expected that a surrounding vehicle that travels around an ego vehicle that autonomously travels will also travel in the middle of a lane. Accordingly, the surrounding vehicle driving trajectory generation module 612a may generate an expected driving trajectory of the surrounding vehicle as the center line of a road incorporated into map information.

The vehicle-being-autonomously-driven driving trajectory generation module 612b may generate an actual driving trajectory of an ego vehicle that autonomously travels that has been driven so far based on the traveling information of the ego vehicle that autonomously travels obtained through the traveling information input interface 201.

Specifically, the vehicle-being-autonomously-driven driving trajectory generation module 612b may generate an actual driving trajectory of an ego vehicle that autonomously travels by making cross reference to a location of the ego vehicle that autonomously travels obtained through the traveling information input interface 201 (i.e., information on the location of the ego vehicle that autonomously travels obtained by the GPS receiver 260) and a given location in map information stored in the memory 620. For example, the vehicle-being-autonomously-driven driving trajectory generation module 612b may specify a current location of an ego vehicle that autonomously travels, in map information, stored in the memory 620, by making cross reference to a location of the ego vehicle that autonomously travels obtained through the traveling information input interface 201 and a given location in the map information. As described above, the vehicle-being-autonomously-driven driving trajectory generation module 612b may generate an actual driving trajectory of the ego vehicle that autonomously travels by continuously monitoring the location of the ego vehicle that autonomously travels. That is, the vehicle-being-autonomously-driven driving trajectory generation module 612b may generate the actual driving trajectory of the ego vehicle that autonomously travels by mapping the location of the ego vehicle that autonomously travels, obtained through the traveling information input interface 201, to a location in the map information stored in the memory 620, based on the cross reference and accumulating the location.

Furthermore, the vehicle-being-autonomously-driven driving trajectory generation module 612b may generate an expected driving trajectory up to the destination of an ego vehicle that autonomously travels based on map information stored in the memory 620.

That is, the vehicle-being-autonomously-driven driving trajectory generation module 612b may generate the expected driving trajectory up to the destination using a current location of the ego vehicle that autonomously travels obtained through the traveling information input interface 201 (i.e., information on the current location of the ego vehicle that autonomously travels obtained through the GPS receiver 260) and the map information stored in the memory 620. Like the expected driving trajectory of the surrounding vehicle, the expected driving trajectory of the ego vehicle that autonomously travels may be generated as the center line of a road incorporated into the map information stored in the memory 620.

The driving trajectories generated by the surrounding vehicle driving trajectory generation module 612a and the vehicle-being-autonomously-driven driving trajectory generation module 612b may be stored in the memory 620, and may be used for various purposes in a process of controlling, by the processor 610, autonomous driving of an ego vehicle that autonomously travels.

The driving trajectory analysis module 613 may diagnose current reliability of autonomous driving control for an ego vehicle that autonomously travels by analyzing driving trajectories (i.e., an actual driving trajectory and expected driving trajectory of a surrounding vehicle and an actual driving trajectory of the ego vehicle that autonomously travels) that are generated by the driving trajectory generation module 612 and stored in the memory 620. The diagnosis of the reliability of autonomous driving control may be performed in a process of analyzing a trajectory error between the actual driving trajectory and expected driving trajectory of the surrounding vehicle.

The driving control module 614 may perform a function for controlling autonomous driving of an ego vehicle that autonomously travels. Specifically, the driving control module 614 may process the autonomous driving algorithm synthetically using the driving information and the traveling information received through the driving information input interface 101 and the traveling information input interface 201, respectively, the information on a surrounding object detected by the sensor unit 500, and the map information stored in the memory 620, may transmit the control information to the low-ranking control system 400 through the vehicle control output interface 401 so that the low-ranking control system 400 controls autonomous driving of an ego vehicle that autonomously travels, and may transmit the driving state information and warning information of the ego vehicle that autonomously travels the output unit 300 through the passenger output interface 301 so that a driver can recognize the driving state information and warning information. Furthermore, when integrating and controlling such autonomous driving, the driving control module 614 controls the autonomous driving by taking into consideration the driving trajectories of an ego vehicle that autonomously travels and a surrounding vehicle, which have been analyzed by the sensor processing module 611, the driving trajectory generation module 612 and the driving trajectory analysis module 613, thereby improving the precision of autonomous driving control and enhancing the safety of autonomous driving control.

The trajectory learning module 615 may perform learning or corrections on an actual driving trajectory of an ego vehicle that autonomously travels generated by the vehicle-being-autonomously-driven driving trajectory generation module 612b. For example, when a trajectory error between an actual driving trajectory and expected driving trajectory of a surrounding vehicle is a preset threshold or more, the trajectory learning module 615 may determine that an actual driving trajectory of an ego vehicle that autonomously travels needs to be corrected by determining that map information stored in the memory 620 is inaccurate. Accordingly, the trajectory learning module 615 may determine a lateral shift value for correcting the actual driving trajectory of the ego vehicle that autonomously travels, and may correct the driving trajectory of the ego vehicle that autonomously travels.

The passenger state determination module 616 may determine a state and behavior of a passenger based on a state and bio signal of the passenger detected by the internal camera sensor 535 and the bio sensor. The state of the passenger determined by the passenger state determination module 616 may be used for autonomous driving control over an ego vehicle that autonomously travels or in a process of outputting a warning to the passenger.

### First Embodiment

A first exemplary embodiment in which the autonomous driving of a vehicle is controlled by selectively applying, based on the state of a passenger, a first expected driving trajectory based on a lane change rate predetermined based on a lane change pattern of a driver and information on the state of a road and a second expected driving trajectory based on a corrected lane change rate is described below based on the aforementioned contents.

Basically, the processor 610 may control the autonomous driving of an ego vehicle based on map information and a lane change rate stored in the memory 620 and an expected driving trajectory (first expected driving trajectory) generated based on driving information of the ego vehicle. In this case, the lane change rate is determined based on a lane change pattern of a driver analyzed based on driving information of an ego vehicle when the ego vehicle changes lanes and information on the state of a road when the ego vehicle changes lanes. The lane change rate indicates a tempo of the lane change of an ego vehicle, and may have been stored in the memory 620.

A lane change rate adopted in the present exemplary embodiment is specifically described. As described above, the lane change rate means a parameter indicative of a tempo of the lane change of an ego vehicle. The tempo of the lane change depends on an entrance steering angle (i.e., a steering angle of an ego vehicle formed by the direction in which the ego vehicle enters a target lane and the direction of the target lane) and an entrance speed (this may mean a lateral speed of the ego vehicle) for entering the target lane when the ego vehicle changes lanes. That is, when the lane change rate is small, this may mean that a lane change may be slowly performed because the entrance steering angle and the entrance speed are small. When the lane change rate is great, this may mean that a lane change may be rapidly performed because the entrance steering angle and the entrance speed are great.

Such a lane change rate may be determined based on a lane change pattern of a driver analyzed based on driving information of an ego vehicle obtained by the driving information detector 200 when the ego vehicle changes lanes based on the manual driving of the driver and information on the state of a road (e.g., the width, curvature and gradient of a road ahead and the number of lanes, which may be detected by the sensor unit 500) when the ego vehicle changes lanes. The lane change rate may be databased based on the driving history of an ego vehicle and stored in the memory 620.

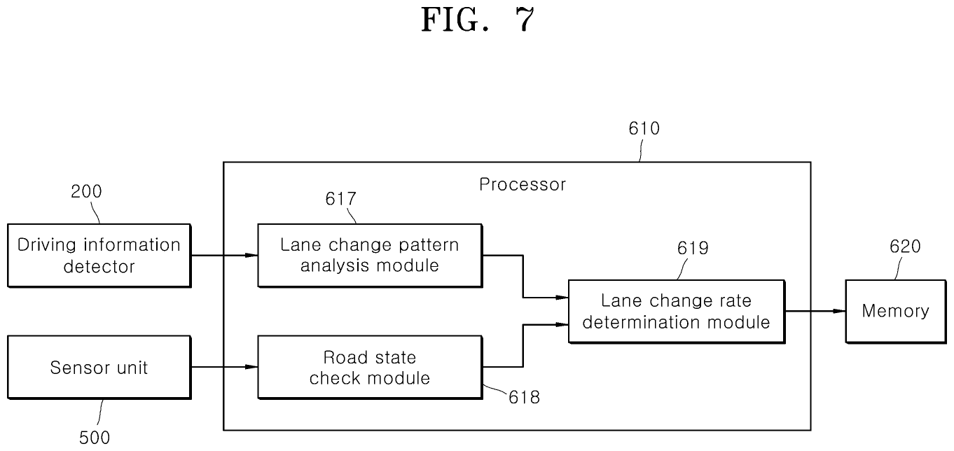

FIG. 7 illustrates a process of a lane change rate being databased and stored in the memory 620. For the databasing of a lane change rate, as illustrated in FIG. 7, the processor 610 according to the present exemplary embodiment may include a lane change pattern analysis module 617, a road state check module 618 and a lane change rate determination module 619, in addition to the modules illustrated in FIG. 2.

The lane change pattern analysis module 617 may analyze a lane change pattern of a driver based on a steering angle when an ego vehicle changes lanes (i.e., a steering angle formed when the driver manipulates a steering wheel), the time taken for the ego vehicle to complete the lane change, and a speed at which the ego vehicle enters a target lane, which are driving information of the ego vehicle detected by the driving information detector 200. For example, the lane change pattern analysis module 617 may analyze a lane change pattern, indicating how long and at which steering angle a driver has performed a lane change, based on a first steering angle at timing at which the lane change of an ego vehicle is initiated, a second steering angle at timing at which the lane change of the ego vehicle is completed, and the time taken for the lane change to be completed. In this case, the timing at which the lane change is initiated may be timing at which the steering angle of the ego vehicle reaches a preset critical steering angle, timing at which an indication direction of an indicator lamp of the ego vehicle and a direction of the steering angle of the ego vehicle are the same, or timing at which it is determined that the steering angle of the ego vehicle is a preset critical steering angle or more, in the state in which the indication direction of the indicator lamp of the ego vehicle and the direction of the steering angle of the ego vehicle are the same. The timing at which the lane change is completed may be timing at which the indicator lamp of the ego vehicle is turned off.

The road state check module 618 may check the state of a road (e.g., the width, curvature and a gradient of a road ahead and the number of lanes) when an ego vehicle changes lanes. The road state check module 618 may check the state of a road using a method of analyzing the results of a road detected, for example, by the sensor unit 500, among objects around an ego vehicle or may check the state of a road using a method of extracting information on the state of the road from map information, stored in the memory 620, based on a current location of the ego vehicle measured by the GPS receiver 260 of the driving information detector 200.

The lane change rate determination module 619 may determine a lane change rate based on a lane change pattern of a driver analyzed by the lane change pattern analysis module 617 and information on the state of a road checked by the road state check module 618. For example, after calculating a lane change pattern index, indicative of a tempo of a lane, change based on a result of the analysis of a lane change pattern, the lane change rate determination module 619 may determine a lane change rate in such a way to increase or decrease the calculated lane change pattern index based on the state of a road (e.g., one or more of the width, curvature and gradient of the road and the number of lanes may be used). Such a lane change rate may be databased based on the state of a road and stored in the memory 620. The processor 610 may generate a first expected driving trajectory for controlling the autonomous driving of an ego vehicle by incorporating a lane change rate, stored in the memory 620, along with map information stored in the memory 620 and driving information of the ego vehicle detected by the driving information detector 200. Accordingly, when controlling the autonomous driving of an ego vehicle based on the first expected driving trajectory (i.e., when lanes are changed in a process in which the autonomous driving of the ego vehicle is performed), the processor 610 may control the autonomous driving of the ego vehicle (i.e., may control a lane change of the ego vehicle) based on an entrance steering angle and entrance speed mapped to a lane change rate incorporated into the first expected driving trajectory.

In a process in which the autonomous driving of an ego vehicle is controlled according to the first expected driving trajectory based on a lane change rate stored in the memory 620, it may be necessary to correct the lane change rate of the ego vehicle based on the state of a passenger. For example, when an emergency situation occurs in a passenger, an ego vehicle may need to more rapidly change lanes to rapidly perform emergency driving or rapidly move to the shoulder. To this end, in the present exemplary embodiment, in a process in which the autonomous driving of an ego vehicle is controlled based on the first expected driving trajectory, the processor 610 may determine whether to maintain autonomous driving control based on the first expected driving trajectory into which a lane change rate has been incorporated, based on the state of a passenger or to change to autonomous driving control based on a second expected driving trajectory into which a corrected lane change rate corrected from the lane change rate has been incorporated. That is, the processor 610 may control the autonomous driving of the ego vehicle by selectively applying the first expected driving trajectory (into which the lane change rate has been incorporated) and the second expected driving trajectory (into which the corrected lane change rate has been incorporated) based on the state of a passenger detected by the sensor unit 500. In order to perform a faster lane change compared to a lane change rate stored in the memory 620, the processor 610 may determine a corrected lane change rate in such a way to map an entrance steering angle and entrance speed having values greater than an entrance steering angle and entrance speed mapped to the lane change rate. Accordingly, when controlling the autonomous driving of the ego vehicle based on the second expected driving trajectory, the processor 610 may control the autonomous driving of the ego vehicle based on the entrance steering angle and entrance speed having values greater than the entrance steering angle and entrance speed mapped to the lane change rate, so that a faster lane change is performed. An increment in an entrance steering angle and entrance speed for a corrected lane change rate compared to a lane change rate may have been previously designed depending on a designer's intention.

Whether the processor 610 will control the autonomous driving of an ego vehicle based on which one of a first expected driving trajectory into which a lane change rate has been incorporated and a second expected driving trajectory into which a corrected lane change rate has been incorporated is determined based on whether a fellow passenger in addition to a driver has got in the ego vehicle and the state of a passenger. Autonomous driving control processes divided based on the state of a passenger are described below.

If a fellow passenger other than a driver has not got in an ego vehicle, when a driving concentration level of the driver determined based on a state of the driver detected by the sensor unit 500 is a preset critical concentration level or more, the processor 610 may control the autonomous driving of the ego vehicle based on a first expected driving trajectory. In this case, the driving concentration level of the driver is a digitalized value of the state of the driver detected by the sensor unit 500, and may be a parameter digitalized based on whether the driver keeps eyes forward, for example. To this end, a given algorithm for computing a driving concentration level by digitalizing the state of a driver may be preset in the passenger state determination module 616 of the processor 610. Furthermore, the critical concentration level is a value, that is, a criterion for determining whether a driver concentrates on driving, and may be selected as a proper value depending on a designer's intention and preset in the passenger state determination module 616.

A driver may need to supervise autonomous driving control based on levels of driving automation (e.g., levels 1 to 3). Accordingly, when a driving concentration level of a driver is a critical concentration level or more (e.g., when the driver keeps eyes forward), this corresponds to a normal state in which an emergency situation has not occurred in the driver. It is preferred to maintain a lane change based on a lane change rate stored in the memory 620, in order to secure autonomous driving stability. To this end, the processor 610 may maintain autonomous driving control over the ego vehicle based on a first expected driving trajectory.

In contrast, when the driving concentration level of the driver is less than the critical concentration level (e.g., when the driver does not keep eyes forward), the processor 610 may output a warning through the output unit 300. After outputting the warning, when the driving concentration level of the driver is restored to the critical concentration level or more, the processor 610 may perform autonomous driving control over the ego vehicle based on a first expected driving trajectory. After outputting the warning, when the driving concentration level of the driver is not restored to the critical concentration level or more, the processor 610 may turn off an autonomous driving mode under the driver's approval to change a driving mode.

If a fellow passenger other than a driver has not got in an ego vehicle, if it is determined that an emergency situation has occurred in the driver based on a state of the driver detected by the sensor unit 500, the processor 610 may control the autonomous driving of the ego vehicle based on a second expected driving trajectory. That is, if it is determined that an emergency situation (e.g., in order to determine the occurrence of the emergency situation in the passenger, such as a respiratory difficulty or cardioplegy, a bio sensor for detecting bio information, such as a heart rate, a pulse beat or blood pressure of the passenger, may be used in addition to the internal camera sensor 535 of the sensor unit 500) has occurred in the driver, a rapid movement of the ego vehicle must be prioritized in order to give first aid to the driver. Accordingly, the processor 610 may induce rapid emergency driving of the ego vehicle or a rapid movement of the ego vehicle to the shoulder by controlling the autonomous driving of the ego vehicle based on a second expected driving trajectory.

If a fellow passenger in addition to a driver has got in an ego vehicle, when it is determined that an emergency situation has occurred in the fellow passenger based on a state of the fellow passenger detected by the sensor unit 500, the processor 610 may control the autonomous driving of the ego vehicle based on a second expected driving trajectory. In this case, a rapid movement of the ego vehicle must be prioritized in order to give first aid to the fellow passenger. Accordingly, the processor 610 may induce rapid emergency driving of the ego vehicle or a rapid movement of the ego vehicle to the shoulder by controlling the autonomous driving of the ego vehicle based on a second expected driving trajectory.

If an emergency situation has occurred in none of a driver and a fellow passenger, the processor 610 may maintain autonomous driving control over the ego vehicle based on a first expected driving trajectory because it is preferred to maintain a lane change based on a lane change rate, stored in the memory 620, in order to secure autonomous driving stability. Furthermore, if it is determined that an emergency situation has occurred in a driver or a fellow passenger, the processor 610 may output a warning through the output unit 300.

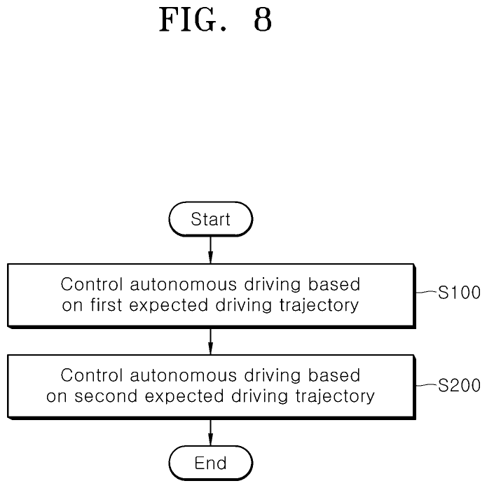

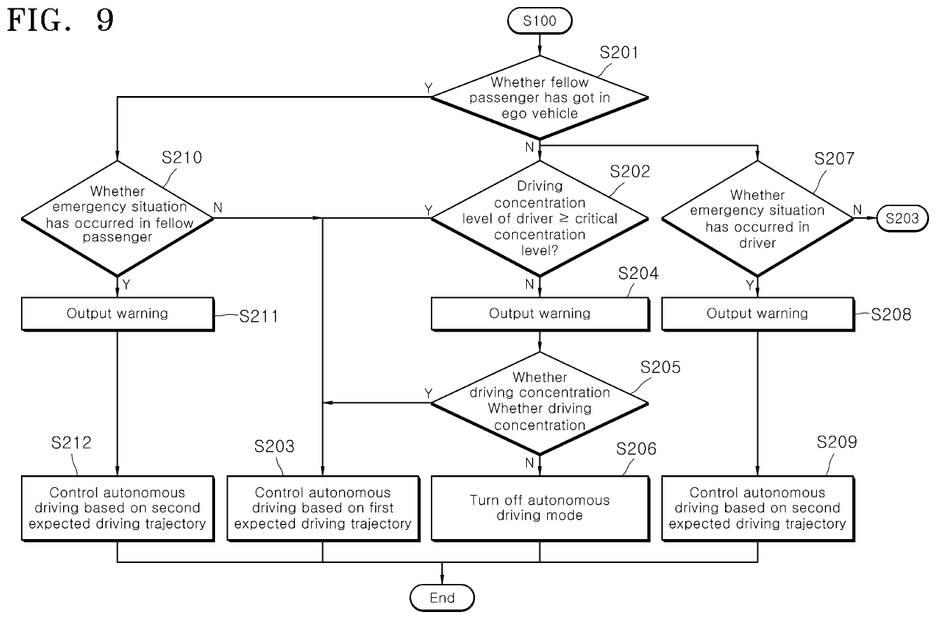

FIGS. 8 and 9 are flowcharts for describing an autonomous driving method according to the first exemplary embodiment of the present invention. Referring to FIG. 8, the autonomous driving method according to the present exemplary embodiment may include a first control step S100 and a second control step S200.

In the first control step S100, the processor 610 controls the autonomous driving of an ego vehicle based on a first expected driving trajectory generated based on map information and a lane change rate stored in the memory 620 and driving information of the ego vehicle. As described above, the lane change rate is determined based on a lane change pattern of a driver analyzed based on driving information of an ego vehicle when the ego vehicle changes lanes and information on the state of a road when the ego vehicle changes lanes. The lane change rate indicates a tempo of the lane change of an ego vehicle, and is stored in the memory 620.

In the second control step S200, the processor 610 controls the autonomous driving of the ego vehicle by selectively applying a first expected driving trajectory and a second expected driving trajectory based on a state of a passenger who has got in the ego vehicle and which is detected by the sensor unit 500. As described above, a corrected lane change rate corrected from a lane change rate stored in the memory 620 has been incorporated into the second expected driving trajectory.

The lane change rate is mapped to an entrance steering angle and entrance speed for entering a target lane when an ego vehicle changes lanes and is stored in the memory 620. Accordingly, when controlling the autonomous driving of an ego vehicle based on a first expected driving trajectory, the processor 610 controls the autonomous driving of the ego vehicle based on an entrance steering angle and entrance speed mapped to a lane change rate.

Furthermore, when controlling the autonomous driving of an ego vehicle based on a second expected driving trajectory, the processor 610 controls the autonomous driving of the ego vehicle based on an entrance steering angle and entrance speed having values greater than an entrance steering angle and entrance speed mapped to a lane change rate.

Step S200 is specifically described with reference to FIG. 9 on the premise of the aforementioned contents. If a fellow passenger other than a driver has not got in an ego vehicle (S201), when a driving concentration level of the driver determined based on a state of the driver detected by the sensor unit 500 is a preset critical concentration level or more (S202), the processor 610 controls the autonomous driving of the ego vehicle based on a first expected driving trajectory (S203). When the driving concentration level of the driver is less than the preset critical concentration level (S202), the processor 610 outputs a warning through the output unit 300 (S204). After outputting the warning, when the driving concentration level of the driver is restored to the critical concentration level or more (S205), the processor 610 performs autonomous driving control over the ego vehicle based on the first expected driving trajectory (S203). After outputting the warning, when the driving concentration level of the driver is not restored to the critical concentration level or more (S205), the processor 610 turns off an autonomous driving mode under the driver's approval to change a driving mode (S206).

Furthermore, if a fellow passenger other than a driver has not got in an ego vehicle (S201), when it is determined that an emergency situation has occurred in the driver, based on a state of the driver detected by the sensor unit 500 (S207), the processor 610 outputs a warning through the output unit 300 (S208), and then controls the autonomous driving of the ego vehicle based on a second expected driving trajectory (S209).

Furthermore, if a fellow passenger in addition to a driver has got in an ego vehicle (S201), when it is determined that an emergency situation has occurred in the fellow passenger, based on a state of the fellow passenger detected by the sensor unit 500 (S210), the processor 610 outputs a warning through the output unit 300 (S211), and then controls the autonomous driving of the ego vehicle based on a second expected driving trajectory (S212).

If an emergency situation has not occurred in the driver at step S207 or an emergency situation has not occurred in the fellow passenger at step S210, the processor 610 performs autonomous driving control over the ego vehicle based on the first expected driving trajectory (S203).

According to the first exemplary embodiment, the present invention can improve the autonomous driving stability of a vehicle and also enables follow-up measures suitable for a state of a passenger, by controlling, depending on the states of a driver and fellow passenger, the autonomous driving of the vehicle by selectively applying a first expected driving trajectory based on a lane change rate predetermined based on a lane change pattern of the driver and information on the state of a road and a second expected driving trajectory based on a corrected lane change rate corrected from the lane change rate.

### Second Embodiment

The present invention includes a second exemplary embodiment which may be applied along with the first exemplary embodiment described above. Hereinafter, the second exemplary embodiment in which an autonomous driving algorithm applied to autonomous driving control is learnt is described. In order to clearly distinguish between terms, the term “autonomous driving algorithm” described below is used to mean an algorithm applied to autonomous driving control over an ego vehicle and the term “surrounding vehicle autonomous-driving algorithm” described below is used to mean an algorithm applied to autonomous driving control over a surrounding vehicle. The following present exemplary embodiment is implemented by a process of updating an autonomous driving algorithm, applied to an ego vehicle, based on a comparison between the accuracy of the autonomous driving algorithm applied to the ego vehicle and the accuracy of a surrounding vehicle autonomous-driving algorithm applied to a surrounding vehicle and a process of performing the learning of the autonomous driving algorithm applied to the ego vehicle. The processes are described below in detail.

First, the processor 610 may control the autonomous driving of an ego vehicle based on map information and an autonomous driving algorithm stored in the memory 620, and may receive a surrounding vehicle autonomous-driving algorithm from a surrounding vehicle around the ego vehicle through V2V communication in a process of controlling the autonomous driving of the ego vehicle. At this time, the processor 610 may determine whether it is necessary to update the autonomous driving algorithm, stored in the memory 620, by comparing the autonomous driving algorithm stored in the memory 620 with the surrounding vehicle autonomous-driving algorithm received from the surrounding vehicle.

In the present exemplary embodiment, a first accuracy index indicative of autonomous driving control accuracy for an ego vehicle may have been mapped to an autonomous driving algorithm. A second accuracy index indicative of autonomous driving control accuracy for a surrounding vehicle may have been mapped to a surrounding vehicle autonomous-driving algorithm. The accuracy index is a quantitative index calculated based on a history in which autonomous driving control over a vehicle has been performed based on the autonomous driving algorithm. For example, the accuracy index may mean an index calculated to indicate control accuracy of the autonomous driving algorithm by synthetically taking into consideration frequency of an accident that occurs when autonomous driving control has been performed based on the autonomous driving algorithm, time taken to reach a destination, traveling distance and fuel efficiency, and frequency of driving manipulation involved by a passenger. An algorithm for calculating the accuracy index through the analysis of accumulated histories in which autonomous driving control has been performed based on the autonomous driving algorithm may also be stored in the memory 620. The calculated accuracy index may be mapped to the autonomous driving algorithm and then stored in the memory 620.

Accordingly, when the second accuracy index mapped to the surrounding vehicle autonomous-driving algorithm is greater than the first accuracy index mapped to the autonomous driving algorithm, the processor 610 may update the autonomous driving algorithm by storing the surrounding vehicle autonomous-driving algorithm in the memory 620. That is, when the second accuracy index is greater than the first accuracy index, the surrounding vehicle autonomous-driving algorithm may be considered as having higher accuracy and reliability than the autonomous driving algorithm. Accordingly, the processor 610 may update the autonomous driving algorithm by storing the surrounding vehicle autonomous-driving algorithm in the memory 620. The update of the autonomous driving algorithm may be performed in real time or periodically in a process of controlling autonomous driving of an ego vehicle.

Through such an update, the processor 610 may determine whether driving manipulation of the passenger of the ego vehicle has been involved in a process of controlling the autonomous driving of the ego vehicle based on an autonomous driving algorithm now stored in the memory 620 (i.e., an autonomous driving algorithm previously stored in the memory 620 or a surrounding vehicle autonomous-driving algorithm received from a surrounding vehicle). In this case, the processor 610 may determine whether the manual driving manipulation, such as a steering manipulation, acceleration pedal manipulation or brake pedal manipulation of the passenger, has been involved, through the steering angle sensor 210 or APS/PTS 220 of the driving information detector 200. If it is determined that the driving manipulation of the passenger has been involved, the learning of the autonomous driving algorithm to be described later may be performed. The processor 610 may stop autonomous driving control over the ego vehicle (i.e., may turn off the autonomous driving mode of the ego vehicle) as a prerequisite for performing the learning of the autonomous driving algorithm.

After the driving manipulation of a passenger is involved and the autonomous driving control is stopped, the processor 610 may allow the learning of the autonomous driving algorithm, now stored in the memory 620, to be performed by taking into consideration the driving manipulation of the passenger. Specifically, the processor 610 may allow the learning of the autonomous driving algorithm to be performed based on a result of a comparison between the driving manipulation of the passenger and a control process according to the autonomous driving algorithm at timing at which the driving manipulation of the passenger is involved. Examples of the control process and the driving manipulation of the passenger may include i) a case where the control process is a lane change process performed through right steering and deceleration and the driving manipulation of the passenger includes right steering for a steering wheel and stepping on a brake pedal, ii) a case where the control process is a lane change process performed through right steering and deceleration and the driving manipulation of the passenger includes left steering for the steering wheel and stepping on the brake pedal, or iii) a case where the control process is a lane change process performed through right steering and deceleration and the driving manipulation of the passenger includes left steering for the steering wheel and stepping on the acceleration pedal.

In the above examples, as in the case of i), if the control process and the driving manipulation of the passenger are the same, the processor 610 may return to the autonomous driving mode again, and may perform autonomous driving control over the ego vehicle based on an autonomous driving algorithm now stored in the memory 620. In the above examples, as in the case of ii) and iii), if the control process and the driving manipulation of the passenger are different, the processor 610 may verify a degree of risk of the driving manipulation of the passenger and then allow the learning of the autonomous driving algorithm to be performed. The degree of risk of the driving manipulation of the passenger may be verified through a process of determining whether an accident has been caused due to the driving manipulation of the passenger. In the case ii) of the above examples, if an accident has not been caused by the left steering and stepping on the brake pedal by the passenger, the processor 610 may determine that the degree of risk of the driving manipulation of the passenger has been verified, and may allow the learning of the autonomous driving algorithm to be performed based on the driving manipulation of the passenger. In the case iii) of the above examples, if an accident has been caused by the left steering and stepping on the acceleration pedal by the passenger, the processor 610 may determine that the degree of risk of the driving manipulation of the passenger has not been verified, may return to the autonomous driving mode again, and may perform autonomous driving control over the ego vehicle based on an autonomous driving algorithm now stored in the memory 620.

In a case where the control process and the driving manipulation of the passenger are different, if the degree of risk of the driving manipulation of the passenger has been verified, the processor 610 may allow the learning of an autonomous driving algorithm to be performed based on information on a surrounding object detected by the sensor unit 500, driving information of the ego vehicle detected by the driving information detector 200, the control process, and the driving manipulation of the passenger. That is, the processor 610 may allow the learning of the autonomous driving algorithm to be performed based on a prepared control process and driving manipulation of the passenger whose degree of risk has been verified according to the autonomous driving algorithm. Furthermore, the processor 610 may allow the learning of the autonomous driving algorithm to be performed by taking into consideration both information on the surrounding object detected by the sensor unit 500 and driving information of the ego vehicle detected by the driving information detector 200, so that active autonomous driving control over a surrounding environment and driving state of the ego vehicle is performed.

The processor 610 may autonomously perform the learning of an autonomous driving algorithm. However, in consideration of a computational load of the learning, the processor 610 may transmit, to the server 700, information on a surrounding object, driving information of an ego vehicle, a control process, and driving manipulation of a passenger so that the learning of the autonomous driving algorithm is performed by the server 700, may receive, from the server 700, the autonomous driving algorithm whose learning has been completed by the server 700, and may control the autonomous driving of the ego vehicle. Furthermore, the processor 610 may propagate, to the surrounding vehicle, the autonomous driving algorithm whose learning has been completed and which is received from the server 700, in order to share the autonomous driving algorithm with the surrounding vehicle.

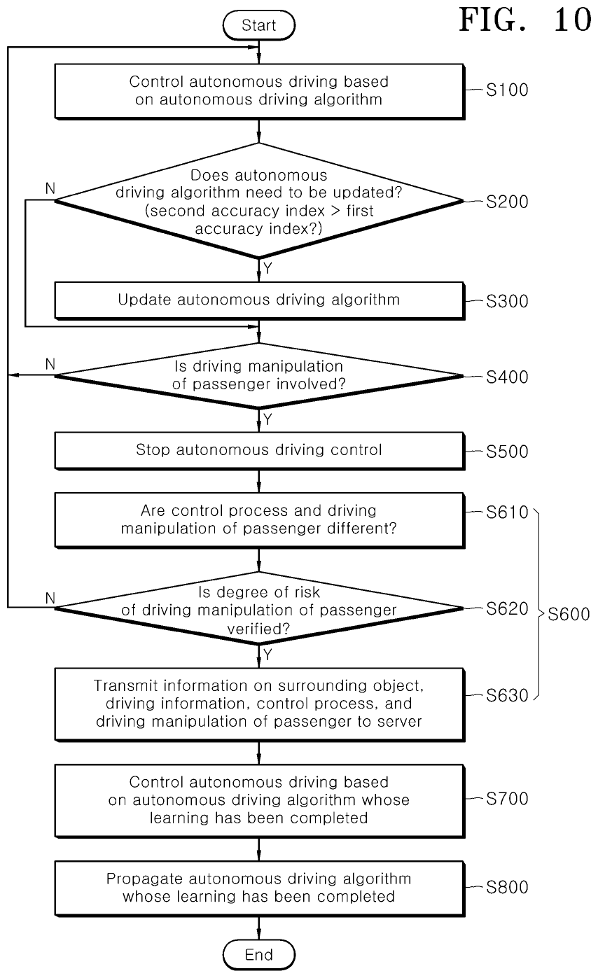

FIG. 10 is a flowchart for describing an autonomous driving method according to the second exemplary embodiment of the present invention.

The autonomous driving method according to the second exemplary embodiment of the present invention is described with reference to FIG. 10. First, the processor 610 controls the autonomous driving of an ego vehicle based on an autonomous driving algorithm stored in the memory 620 (S100).

Next, the processor 610 determines whether to update the autonomous driving algorithm stored in the memory 620, by comparing the autonomous driving algorithm stored in the memory 620 with a surrounding vehicle autonomous-driving algorithm received from a surrounding vehicle (S200). As described above, a first accuracy index indicative of autonomous driving control accuracy for the ego vehicle has been mapped to the autonomous driving algorithm. A second accuracy index indicative of autonomous driving control accuracy for the surrounding vehicle has been mapped to the surrounding vehicle autonomous-driving algorithm. When the second accuracy index mapped to the surrounding vehicle autonomous-driving algorithm is greater than the first accuracy index mapped to the autonomous driving algorithm at step S200, the processor 610 determines that it is necessary to update the autonomous driving algorithm.

If it is determined at step S200 that it is necessary to update the autonomous driving algorithm, the processor 610 updates the autonomous driving algorithm by storing the surrounding vehicle autonomous-driving algorithm in the memory 620 (S300).

Next, the processor 610 determines whether driving manipulation of a passenger has been involved in a process of controlling the autonomous driving of the ego vehicle based on the autonomous driving algorithm now stored in the memory 620 through the update (S400).

If it is determined at step S400 that the driving manipulation of the passenger has been involved, the processor 610 stops autonomous driving control over the ego vehicle (S500).

Thereafter, the processor 610 allows the learning of the autonomous driving algorithm, now stored in the memory 620, to be performed by taking into consideration the driving manipulation of the passenger. Specifically, the processor 610 allows the learning of the autonomous driving algorithm to be performed based on a result of a comparison between the driving manipulation of the passenger and a control process according to the autonomous driving algorithm at timing at which the driving manipulation of the passenger is involved (S600).

At step S600, the processor 610 compares the driving manipulation of the passenger with the control process according to the autonomous driving algorithm at the timing at which the driving manipulation of the passenger is involved (S610), verifies the degree of risk of the driving manipulation of the passenger if the control process and the driving manipulation of the passenger are different (S620), and allows the learning of the autonomous driving algorithm to be performed based on the control process and the driving manipulation of the passenger, if the degree of risk of the driving manipulation of the passenger has been verified (S630). At step S630, the processor 610 may allow the learning of the autonomous driving algorithm to be performed by further taking into consideration information on a surrounding object around the ego vehicle and driving information of the ego vehicle. The processor 610 may transmit, to the server 700, the information on the surrounding object, the driving information of the ego vehicle, the control process, and the driving manipulation of the passenger, so that the learning of the autonomous driving algorithm is performed by the server 700.

Thereafter, the processor 610 receives, from the server 700, the autonomous driving algorithm whose learning is performed by the server 700, controls the autonomous driving of the ego vehicle (S700), and propagates, to the surrounding vehicle, the autonomous driving algorithm whose learning has been completed and which is received from the server 700, in order to share the autonomous driving algorithm with the surrounding vehicle (S800).

According to the second exemplary embodiment, the driving stability and driving accuracy of an autonomous vehicle can be improved by learning an autonomous driving algorithm, applied to autonomous driving control, by taking into consideration driving manipulation of a passenger involved in an autonomous driving control process for an ego vehicle, and then controlling the autonomous driving of the ego vehicle based on the autonomous driving algorithm whose learning has been completed.

### Third Embodiment

The present invention includes a third exemplary embodiment which may be applied along with the first and second exemplary embodiments described above. Hereinafter, the third exemplary embodiment in which a trajectory up to a target point is modified when the target point, such as a crossroad or junction, is present in the autonomous driving path of an ego vehicle is described in detail.

As described above, after generating an expected driving trajectory of an ego vehicle based on map information stored in the memory 620, (the driving trajectory generation module 612 of) the processor 610 according to the present exemplary embodiment may control the autonomous driving of the ego vehicle based on the generated expected driving trajectory. The processor 610 may generate the expected driving trajectory of the ego vehicle as the middle line of a lane incorporated into the map information stored in the memory 620.

At this time, the processor 610 may generate an expected driving trajectory and actual driving trajectory of a surrounding vehicle based on the map information stored in the memory 620 and driving information of the surrounding vehicle detected by the sensor unit 500. When a trajectory error between the expected driving trajectory and actual driving trajectory of the surrounding vehicle is a preset critical value or more, the processor 610 may update the map information, stored in the memory 620, with new map information received from the server 700. After generating an expected driving trajectory of the ego vehicle based on the updated map information, the processor 610 may control the autonomous driving of the ego vehicle.

Specifically, as described above, (the driving trajectory generation module 612 of) the processor 610 may generate the expected driving trajectory of the surrounding vehicle based on the map information stored in the memory 620. In this case, the processor 610 may generate the expected driving trajectory of the surrounding vehicle as the middle line of a lane incorporated into the map information stored in the memory 620.

Furthermore, (the driving trajectory generation module 612 of) the processor 610 may generate the actual driving trajectory of the surrounding vehicle based on driving information of the surrounding vehicle detected by the sensor unit 500. That is, when a surrounding vehicle is detected at a specific point by the sensor unit 500, the processor 610 may specify the location of the surrounding vehicle, currently detected in the map information stored in the memory 620, by making cross reference to the location of the detected surrounding vehicle and a location in the map information. As described above, the processor 610 may generate an actual driving trajectory of the surrounding vehicle by continuously monitoring the location of the surrounding vehicle.

After the expected driving trajectory and actual driving trajectory of the surrounding vehicle are generated, when a trajectory error between the expected driving trajectory and actual driving trajectory of the surrounding vehicle is a preset critical value or more, the processor 610 may determine that the map information stored in the memory 620 is inaccurate. Accordingly, the processor 610 may update the map information, stored in the memory 620, with new map information received from the server 700. Accordingly, after generating an expected driving trajectory of the ego vehicle based on the updated map information, that is, the new map information, the processor 610 may control the autonomous driving of the ego vehicle. The process of updating the map information stored in the memory 620 functions as a premise process for improving the accuracy of a modification of a trajectory up to a target point, which is described hereinafter.

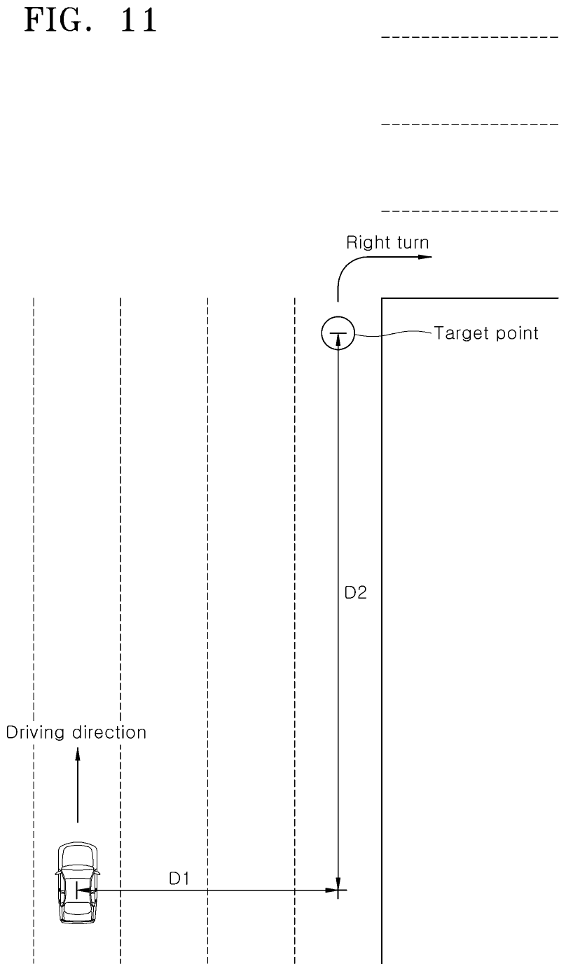

In a process of controlling the autonomous driving of an ego vehicle based on an expected driving trajectory of the ego vehicle, when a target point at which the driving direction of the ego vehicle is changed is present ahead of the ego vehicle, (the trajectory learning module 615 of) the processor 610 may modify, based on a distance from the current location of the ego vehicle to the target point, a target trajectory that belongs to the expected driving trajectory of the ego vehicle and that corresponds to a trajectory between a current location of the ego vehicle and the target point, so that the ego vehicle can reach the target point through a lane change. In this case, the target point at which the driving direction of the ego vehicle is changed may mean a point at which the ego vehicle turns to the left or right in the crossroad where the left turn or right turn is scheduled or a left entry and exit road and a right entry and exit road, such as an interchange or junction in an expressway, as illustrated in FIG. 11.

That is, when a target point at which a left turn or right turn is scheduled, such as a crossroad, an interchange or a junction, is present ahead of an ego vehicle, the processor 610 may allow the ego vehicle to previously perform a step-by-step lane change before the ego vehicle reaches the target point so that the ego vehicle can change its driving direction at the target point. In the present exemplary embodiment, a configuration for modifying a target trajectory between a current location of an ego vehicle and a target point based on a distance from the current location of the ego vehicle to the target point is adopted as means for performing the step-by-step lane change.

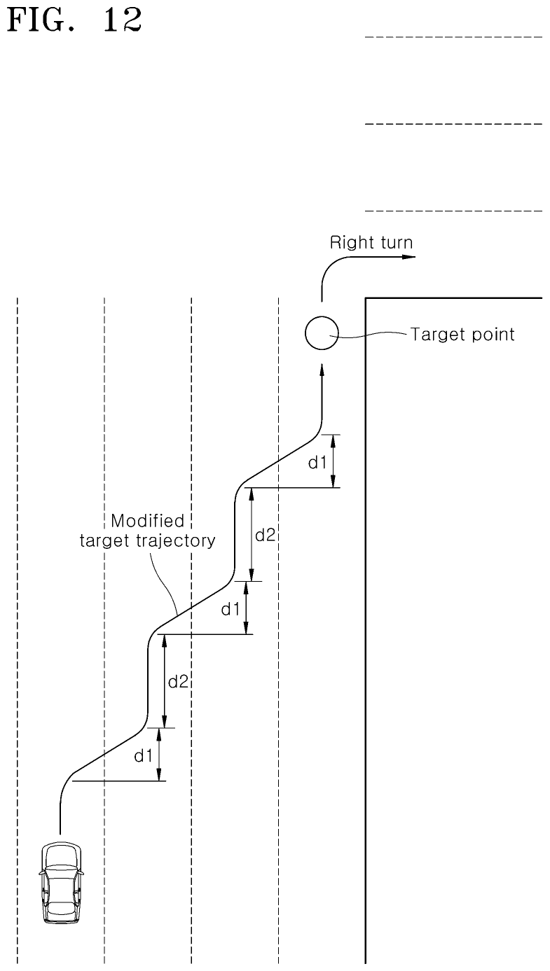

The configuration for modifying a target trajectory is specifically described. When a lateral distance and a longitudinal distance between a current location of an ego vehicle and a target point are a preset first critical distance or more and a preset second critical distance or more, respectively, the processor 610 may modify a target trajectory. In this case, as illustrated in FIGS. 11 and 12 (only some of the right lanes based on the centerline are illustrated in FIGS. 11 and 12 for the sake of convenience), a lateral distance D1 and longitudinal distance D2 between a current location of an ego vehicle and a target point mean a lateral vertical distance and longitudinal vertical distance between the current location of the ego vehicle and the target point.

When the lateral distance between the current location of the ego vehicle and the target point is less than the first critical distance, the processor 610 may modify a target trajectory only when the lateral distance is the first critical distance or more because a need for a step-by-step lane change for reaching the target point is low. Furthermore, the processor 610 may modify the target trajectory at timing at which the longitudinal distance is the second critical distance or more so that the ego vehicle can secure driving stability by performing a step-by-step lane change in the state in which a longitudinal margin distance for a lane change has been secured. The first and second critical distances may be variously selected depending on a designer's intention and previously stored in the memory 620. Furthermore, the processor 610 may modify the target trajectory at timing at which the lateral distance and the longitudinal distance between the current location of the ego vehicle and the target point are the first critical distance or more and the second critical distance or more, respectively. However, the timing at which the target trajectory is modified does not need to be limited to specific timing.

When the lateral distance and the longitudinal distance between the current location of the ego vehicle and the target point are the first critical distance or more and the second critical distance or more, respectively, the processor 610 may modify the target trajectory based on the lateral distance and longitudinal distance between the current location of the ego vehicle and the target point, so that the ego vehicle can reach the target point by performing a step-by-step lane change to a lane present between the current location of the ego vehicle and the target point. At this time, the processor 610 may modify the target trajectory using a method of determining a first longitudinal traveling distance in which the ego vehicle will travel and a second longitudinal traveling distance in which the ego vehicle will travel in a changed lane, in the process in which the ego vehicle completes the lane change after initiating the lane change to a neighbor lane based on the lateral distance and longitudinal distance between the current location of the ego vehicle and the target point.

A process of modifying a target trajectory for a step-by-step lane change of an ego vehicle is described below based on the example of FIG. 12. A modification of a target trajectory may be performed through a process of determining a first longitudinal traveling distance “d1” (in distinction from the aforementioned “longitudinal distance”, the distance in which the ego vehicle has longitudinally traveled in a lane change process is indicated as a “longitudinal traveling distance”) in which an ego vehicle has longitudinally traveled and a second longitudinal traveling distance “d2” in which the ego vehicle has longitudinally traveled in a changed lane, in a process of completing a lane change to a neighbor lane after initiating the lane change. A degree of driving risk increases because a lane change pattern of the ego vehicle becomes a sudden lane change pattern in a lateral direction as the first and second longitudinal traveling distances become smaller. In contrast, a degree of driving risk decreases because the lane change pattern of the ego vehicle becomes a step-by-step lane change pattern in the lateral direction as the first and second longitudinal traveling distances become greater.

As described above, in the present exemplary embodiment, a condition in which a lateral distance and a longitudinal distance between a current location of an ego vehicle and a target point are a first critical distance or more and a second critical distance or more, respectively, has been adopted as a condition for modifying a target trajectory. If first and second longitudinal traveling distances are determined based on the lateral distance and longitudinal distance equal to or greater than the first critical distance and second critical distance, respectively, a step-by-step lane change pattern of the ego vehicle can be implemented because the first and second longitudinal traveling distances have given values or more. In this respect, the processor 610 may modify the target trajectory using a method of determining the first and second longitudinal traveling distances based on the lateral distance and longitudinal distance between the current location of the ego vehicle and the target point, so that the step-by-step lane change of the ego vehicle is performed. A method of determining the first and second longitudinal traveling distances based on the lateral distance and longitudinal distance within a range determined so that the first and second longitudinal traveling distances have given values or more may be implemented in various ways. Lane change initiation timing and lane change completion timing, that is, criteria for determining the first and second longitudinal traveling distances, may be determined by an algorithm that has been previously designed and defined depending on a designer's intention.

When the target trajectory is modified using the aforementioned method, the processor 610 may control the autonomous driving of the ego vehicle so that the ego vehicle travels based on the modified target trajectory.

If an ego vehicle reaches a destination and performs parking, the processor 610 may generate a parking trajectory, on which the ego vehicle reaches a parking location into which parking preference of the passenger of the ego vehicle has been incorporated, based on parking map information on a parking space, and may control the autonomous parking of the ego vehicle based on the generated parking trajectory.

Specifically, the processor 610 may receive the parking map information (i.e., map information into which a parking zone, a parking section and a shape of the parking space have been incorporated) for the parking space from parking infrastructure (e.g., a parking management server) for managing parking in the parking space. Furthermore, the processor 610 may check parking preference of the passenger based on parking preference information (e.g., a parking zone closest to the entrance or exit of the parking space, a parking zone closest to a store, a parking zone in which the number of other vehicles parking nearby is the smallest, a parking zone on the left side of a pillar or a parking zone on the right side of a pillar) input to the user terminal 120 by the passenger. The parking preference may mean parking preference information itself input by the passenger, or may mean information in which order of priority designated by the passenger has been assigned to a plurality of pieces of parking preference information input by the passenger (e.g., ranking 1—a parking zone closest to the entrance or exit of a parking space, ranking 2—a parking zone closest to a store, and ranking 3—a parking zone in which the number of other vehicles parking nearby is the smallest).

Accordingly, the processor 610 may generate a parking trajectory on which an ego vehicle reaches an optimal parking location, desired by a passenger, by incorporating parking preference of the passenger into parking map information, and may control the autonomous parking of the ego vehicle based on the generated parking trajectory, so that parking convenience of the passenger of the ego vehicle is improved.

In this case, when there is a vehicle ahead that enters the parking space, the processor 610 may receive a parking trajectory of the vehicle ahead, may generate a parking trajectory and parking location of the ego vehicle so that they do not overlap the parking trajectory and parking location of the vehicle ahead, and may control the autonomous parking of the ego vehicle. That is, the processor 610 may receive the parking trajectory of the vehicle ahead from the vehicle ahead, and may check the parking trajectory and target parking location of the vehicle ahead. In order to reduce inconvenience attributable to the time taken for parking that is increased as the moving trajectory of the vehicle ahead and the moving trajectory of the ego vehicle overlap in the parking space, the processor 610 may generate the parking trajectory and parking location of the ego vehicle so that they do not overlap the parking trajectory and parking location of the vehicle ahead, and may control the autonomous parking of the ego vehicle.

In contrast, when there is a vehicle behind that enters the parking space, the processor 610 may transmit the parking trajectory of the ego vehicle to the vehicle behind so that the parking trajectory and parking location of the ego vehicle do not overlap a parking trajectory and parking location of the vehicle behind. Accordingly, parking inconvenience attributable to the overlap of moving trajectories between the ego vehicle and the vehicle behind can be reduced because the vehicle behind determines its parking trajectory and parking location not overlapping the parking trajectory and parking location of the ego vehicle and travels based on the determined parking trajectory and parking location.

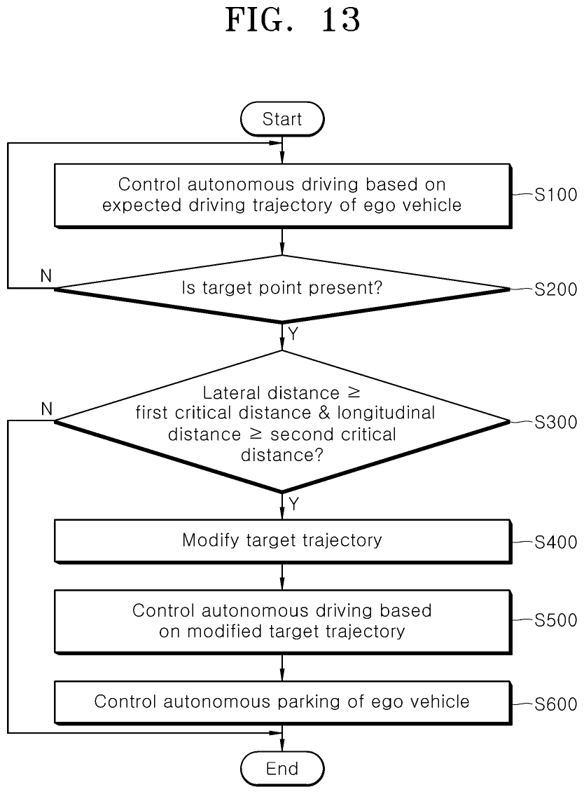

FIG. 13 is a flowchart for describing an autonomous driving method according to the third exemplary embodiment of the present invention.

An autonomous driving method according to the third exemplary embodiment of the present invention is described with reference to FIG. 13. The processor 610 controls the autonomous driving of an ego vehicle based on an expected driving trajectory of the ego vehicle generated based on map information stored in the memory 620 (S100).

At step S100, the processor 610 generates an expected driving trajectory and actual driving trajectory of a surrounding vehicle based on the map information stored in the memory 620 and driving information of the surrounding vehicle detected by the sensor unit 500. When a trajectory error between the expected driving trajectory and actual driving trajectory of the surrounding vehicle is a preset critical value or more, the processor 610 may update the map information, stored in the memory 620, with new map information received from the server 700, may generate an expected driving trajectory of the ego vehicle based on the updated map information, and may control the autonomous driving of the ego vehicle.

In a process of controlling the autonomous driving of the ego vehicle based on the expected driving trajectory of the ego vehicle, the processor 610 determines whether a target point at which the driving direction of the ego vehicle is changed is present ahead of the ego vehicle (S200). At step S200, the processor 610 may determine whether the target point is present ahead of the ego vehicle with reference to the map information (may be the updated map information) stored in the memory 620.

If it is determined at step S200 that the target point is present ahead of the ego vehicle, the processor 610 determines whether a lateral distance and a longitudinal distance between a current location of the ego vehicle and a target point are a preset first critical distance or more and a preset second critical distance or more, respectively (S300).

If it is determined at step S300 that the lateral distance and the longitudinal distance between the current location of the ego vehicle and the target point are the first critical distance or more and the second critical distance or more, respectively, the processor 610 modifies a target trajectory that belongs to the expected driving trajectory of the ego vehicle and that corresponds to a trajectory between the current location of the ego vehicle and the target point, based on a distance from the current location of the ego vehicle to the target point, so that the ego vehicle can reach the target point through a lane change (S400).

At step S400, the processor 610 may modify the target trajectory based on the lateral distance and longitudinal distance between the current location of the ego vehicle and the target point, so that the ego vehicle can reach the target point by performing a step-by-step lane change to a lane present between the current location of the ego vehicle and the target point. Specifically, the processor 610 may modify the target trajectory using a method of determining a first longitudinal traveling distance in which the ego vehicle will travel and a second longitudinal traveling distance in which the ego vehicle will travel in a changed lane, in the process where the ego vehicle completes the lane change after initiating the lane change to a neighboring lane based on the lateral distance and longitudinal distance between the current location of the ego vehicle and the target point.

When the target trajectory is modified at step S400, the processor 610 controls the autonomous driving of the ego vehicle so that the ego vehicle travels based on the modified target trajectory (S500).

If the ego vehicle reaches a destination through the autonomous driving process according to step S500 and performs parking, the processor 610 generates a parking trajectory, on which the ego vehicle reaches a parking location into which parking preference of the passenger of the ego vehicle has been incorporated, based on parking map information on a parking space, and controls the autonomous parking of the ego vehicle based on the generated parking trajectory (S600). At step S600, when there is a vehicle ahead that enters the parking space, the processor 610 may receive a parking trajectory of the vehicle ahead, may generate a parking trajectory and parking location of the ego vehicle so that they do not overlap the parking trajectory and parking location of the vehicle ahead, and may perform the autonomous parking of the ego vehicle. In contrast, when there is a vehicle behind that enters the parking space, the processor 610 may transmit a parking trajectory of the ego vehicle to the vehicle behind so that the parking trajectory and parking location of the ego vehicle do not overlap a parking trajectory and parking location of the vehicle behind.

According to the third exemplary embodiment, if a target point at which the driving direction of an ego vehicle is changed, such as a crossroad or junction, is present in the autonomous driving path of the ego vehicle, a trajectory up to the target point is modified based on a distance between a current location of the ego vehicle and the target point, so that the ego vehicle can reach the target point through a step-by-step lane change. Accordingly, the driving stability of the ego vehicle can be secured in a process of traveling based on the trajectory up to the target point. Furthermore, if the parking of an ego vehicle is performed, parking convenience of a passenger can be improved by controlling the autonomous parking of the ego vehicle so that the ego vehicle can reach a parking location into which parking preference of the passenger has been incorporated.

### Fourth Embodiment

The present invention includes a fourth exemplary embodiment which may be applied along with the first to third exemplary embodiments described above. Hereinafter, the fourth exemplary embodiment in which a driving trajectory of an ego vehicle is modified during autonomous driving is described in detail.

As described above, (the driving trajectory generation module 612 of) the processor 610 according to the present exemplary embodiment may generate an actual driving trajectory of a surrounding vehicle based on driving information of the surrounding vehicle detected by the sensor unit 500. That is, when the surrounding vehicle is detected at a specific point by the sensor unit 500, the processor 610 may specify the location of the surrounding vehicle currently detected in map information stored in the memory 620 by making cross reference to the location of the detected surrounding vehicle and a location in the map information. As described above, the processor 610 may generate the actual driving trajectory of the surrounding vehicle by continuously monitoring the location of the surrounding vehicle.

Furthermore, (the driving trajectory generation module 612 of) the processor 610 may generate an expected driving trajectory of the surrounding vehicle based on the map information stored in the memory 620. In this case, the processor 610 may generate the expected driving trajectory of the surrounding vehicle as the middle line of a lane incorporated into the map information stored in the memory 620.

Furthermore, (the driving trajectory generation module 612 of) the processor 610 may generate an expected driving trajectory of the ego vehicle based on the map information stored in the memory 620. In this case, the processor 610 may generate the expected driving trajectory of the ego vehicle as the middle line of a lane incorporated into the map information.

After the actual driving trajectory and expected driving trajectory of the surrounding vehicle and the expected driving trajectory of the ego vehicle are generated, if it is determined that the expected driving trajectory of the ego vehicle needs to be corrected, based on a comparison between the actual driving trajectory and expected driving trajectory of the surrounding vehicle, (the trajectory learning module 615 of) the processor 610 may correct the expected driving trajectory of the ego vehicle based on a degree of risk according to a distance from the ego vehicle to a target surrounding vehicle. In this case, the target surrounding vehicle may include first and second target surrounding vehicles traveling on the left and right sides of the ego vehicle, respectively. Hereinafter, a case where the ego vehicle travels between the first and second target surrounding vehicles is assumed. Furthermore, in the present exemplary embodiment, the term “target surrounding vehicle” is used to describe that the target surrounding vehicle is a surrounding vehicle, that is, a criterion for correcting the expected driving trajectory of the ego vehicle. However, the target surrounding vehicle may refer to the same vehicle as a surrounding vehicle whose actual driving trajectory and expected driving trajectory are calculated by the surrounding vehicle driving trajectory generation module 612a.

When a trajectory error between the actual driving trajectory and expected driving trajectory of the surrounding vehicle is a preset critical value or more, the processor 610 may determine that the expected driving trajectory of the ego vehicle needs to be corrected. That is, as described above, when the trajectory error between the actual driving trajectory and expected driving trajectory of the surrounding vehicle is the critical value or more, the processor 610 may determine that the map information stored in the memory 620 is inaccurate. Accordingly, it is also necessary to correct the expected driving trajectory of the ego vehicle generated based on the map information stored in the memory 620.

If it is determined that it is necessary to correct the expected driving trajectory of the ego vehicle as described above, the processor 610 may correct the expected driving trajectory of the ego vehicle in the direction in which a degree of driving risk of the ego vehicle is low, based on a lateral distance between the ego vehicle and a first target surrounding vehicle and a lateral distance between the ego vehicle and a second target surrounding vehicle. When the lateral distance between the ego vehicle and the first target surrounding vehicle is defined as a first lateral distance and the lateral distance between the ego vehicle and the second target surrounding vehicle is defined as a second lateral distance, the first and second lateral distances may mean distances between a straight line, extended in the driving direction of the ego vehicle, and the first and second target surrounding vehicles, respectively. The processor 610 may compare the first and second lateral distances, may determine that a degree of driving risk to the left is lower, when the first lateral distance is greater, and may determine that a degree of driving risk to the right is lower, when the second lateral distance is greater.

In this case, the processor 610 may correct the expected driving trajectory of the ego vehicle using a method of determining a shift value for allowing the ego vehicle to travel by laterally shifting the ego vehicle (i.e., for correcting the expected driving trajectory of the ego vehicle). That is, the processor 610 may determine a primary shift value for correcting the expected driving trajectory of the ego vehicle in the direction in which a degree of driving risk of the ego vehicle is low, may determine a final shift value by correcting the primary shift value based on a weight indicative of a degree of risk of approach when the ego vehicle approaches the first and second target surrounding vehicles, and then may correct the expected driving trajectory of the ego vehicle based on the determined final shift value.

Specifically, the processor 610 may determine the primary shift value for correcting the expected driving trajectory of the ego vehicle in the direction in which the degree of driving risk of the ego vehicle is low. For example, when a first lateral distance is greater than a second lateral distance, the processor 610 may determine a primary shift value for shifting an expected driving trajectory of the ego vehicle to the left. The size of the primary shift value may be determined as ½ of a value obtained by subtracting the second lateral distance from the first lateral distance, for example (i.e., the size of the primary shift value may be determined so that the ego vehicle travels in the middle between the first and second target surrounding vehicles). Likewise, when a second lateral distance is greater than a first lateral distance, the processor 610 may determine a primary shift value for shifting an expected driving trajectory of the ego vehicle to the right. The size of the primary shift value may be determined as ½ of a value obtained by subtracting the first lateral distance from the second lateral distance, for example. Furthermore, a shift direction for the expected driving trajectory of the ego vehicle may be indicated as a sign (e.g., a sign (−) is the left, and a sign (+) is the right) of the primary shift value. The size of the shift value may be indicated as an absolute value.

Thereafter, the processor 610 may determine the final shift value by correcting the primary shift value based on a weight indicative of a degree of risk of approach when the ego vehicle approaches the first and second target surrounding vehicles. The weight indicative of a degree of risk of approach when the ego vehicle approaches the first and second target surrounding vehicles may mean, for example, a parameter for correcting a primary shift value in order for the ego vehicle to travel in the state in which the ego vehicle has approached a target surrounding vehicle that belong to the first and second target surrounding vehicles and that has a smaller volume (or size). For example, if the first target surrounding vehicle is a full-size car and the second target surrounding vehicle is a compact car, assuming that the primary shift value has been determined as a value of (+) because the second lateral distance is greater than the first lateral distance, the final shift value may be determined to have a value greater than the primary shift value by applying the weight. A degree of an increase or decrease in the primary shift value for determining the final shift value, that is, the weight may be variously selected depending on a designer's intention and previously stored in the memory 620.

Accordingly, the processor 610 may correct the expected driving trajectory of the ego vehicle based on the final shift value. Accordingly, through such a correction of the expected driving trajectory of the ego vehicle, the autonomous driving stability of the ego vehicle can be secured because the expected driving trajectory of the ego vehicle generated by the ego vehicle driving trajectory generation module 612b is shifted by the final shift value prior to the correction in a process in which the autonomous driving of the ego vehicle is controlled based on the map information stored in the memory 620.

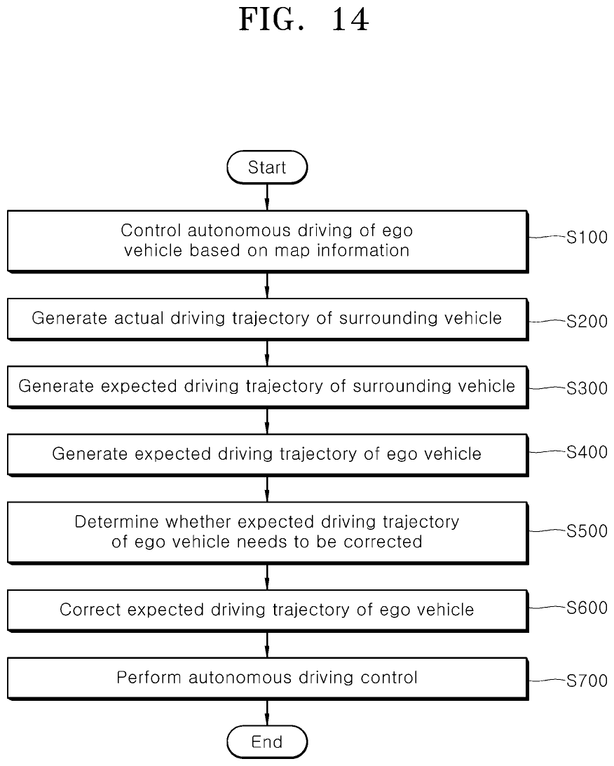

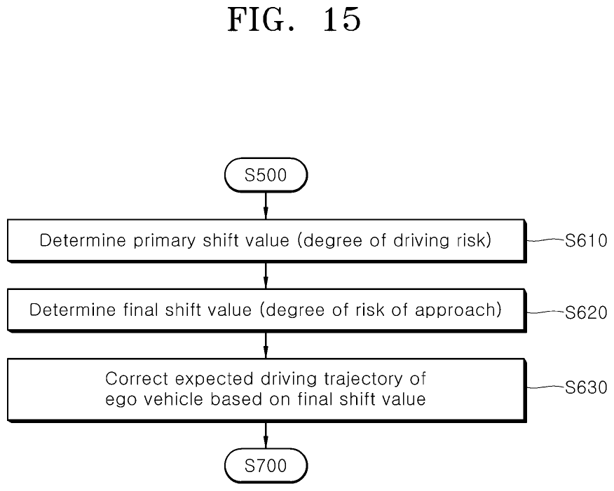

FIGS. 14 and 15 are flowcharts for describing an autonomous driving method according to the fourth exemplary embodiment of the present invention.

An autonomous driving method according to the fourth exemplary embodiment of the present invention is described with reference to FIG. 14. First, the processor 610 controls the autonomous driving of an ego vehicle based on map information stored in the memory 620 (S100).

Thereafter, the processor 610 generates an actual driving trajectory of a surrounding vehicle based on driving information of the surrounding vehicle, detected by the sensor unit 500, in a process in which the autonomous driving of the ego vehicle is performed (S200).

Next, the processor 610 generates an expected driving trajectory of the surrounding vehicle based on the map information stored in the memory 620 (S300).

Next, the processor 610 generates an expected driving trajectory of the ego vehicle based on the map information stored in the memory 620 (S400).

Next, the processor 610 determines whether the expected driving trajectory of the ego vehicle needs to be corrected, based on a comparison between the actual driving trajectory and expected driving trajectory of the surrounding vehicle (S500). At step S500, when a trajectory error between the actual driving trajectory and expected driving trajectory of the surrounding vehicle is a preset critical value or more, the processor 610 determines that the expected driving trajectory of the ego vehicle needs to be corrected.

If it is determined at step S500 that the expected driving trajectory of the ego vehicle needs to be corrected, the processor 610 corrects the expected driving trajectory of the ego vehicle based on a degree of risk according to a distance from the ego vehicle to a target surrounding vehicle (S600). At step S600, the processor 610 corrects the expected driving trajectory of the ego vehicle in the direction in which a degree of driving risk of the ego vehicle is low, based on a first lateral distance between the ego vehicle and a first target surrounding vehicle and a second lateral distance between the ego vehicle and a second target surrounding vehicle.

Step S600 is specifically described with reference to FIG. 15. The processor 610 determines the direction in which a degree of driving risk of the ego vehicle is low, based on a comparison between the first and second lateral distances, and determines a primary shift value for correcting the expected driving trajectory of the ego vehicle in the determined direction (S610).

Furthermore, the processor 610 determines the final shift value by correcting the primary shift value based on a weight indicative of a degree of risk of approach for a case where the ego vehicle approaches the first and second target surrounding vehicles (S620).

Furthermore, the processor 610 corrects the expected driving trajectory of the ego vehicle based on the final shift value determined at step S620 (S630).

When the expected driving trajectory of the ego vehicle is corrected at step S600, the processor 610 performs normal autonomous driving control (S700).

According to the fourth exemplary embodiment, the driving stability and driving accuracy of an autonomous vehicle can be improved by determining a need to correct the driving trajectory of the autonomous vehicle and correcting a driving trajectory of the autonomous vehicle by taking into consideration a degree of risk based on a distance between an ego vehicle and a surrounding vehicle based on a result of the determination.

### Fifth Embodiment

The present invention includes a fifth exemplary embodiment which may be applied along with the first to fourth exemplary embodiments described above. Hereinafter, the fifth exemplary embodiment in which the reliability of autonomous driving control over an ego vehicle that autonomously travels is diagnosed and a resultant warning is output is described.

As described above, (the driving trajectory generation module 612 of) the processor 610 according to the present exemplary embodiment may generate an actual driving trajectory of a surrounding vehicle based on driving information of the surrounding vehicle detected by the sensor unit 500. That is, when the surrounding vehicle is detected at a specific point by the sensor unit 500, the processor 610 may specify the location of the surrounding vehicle currently detected in the map information by making cross reference to the location of the detected surrounding vehicle and a location in the map information stored in the memory 620. The processor 610 may generate the actual driving trajectory of the surrounding vehicle by continuously monitoring the location of the surrounding vehicle as described above.

Furthermore, (the driving trajectory generation module 612 of) the processor 610 may generate an expected driving trajectory of the surrounding vehicle based on the map information stored in the memory 620. In this case, the processor 610 may generate the expected driving trajectory of the surrounding vehicle as the middle line of a lane incorporated into the map information.

When the actual driving trajectory and expected driving trajectory of the surrounding vehicle are generated, (the driving trajectory analysis module 613 of) the processor 610 may perform the diagnosis of reliability of autonomous driving control over the ego vehicle based on the size of a trajectory error between the actual driving trajectory and expected driving trajectory of the surrounding vehicle or an cumulative addition of the trajectory errors.

Specifically, the state in which a trajectory error between the actual driving trajectory and expected driving trajectory of the surrounding vehicle is present may correspond to the state in which the autonomous driving control performed on the ego vehicle is unreliable. That is, if an error is present between the actual driving trajectory generated based on driving information of the surrounding vehicle detected by the sensor unit 500 and the expected driving trajectory generated based on map information stored in the memory 620, this means the state in which the surrounding vehicle does not travel along the centerline of a lane along which the surrounding vehicle is expected to travel in the map information. This means that there is the possibility that the surrounding vehicle might be erroneously detected by the sensor unit 500 or the possibility that the map information stored in the memory 620 may be inaccurate. That is, two possibilities may be present. First, although a surrounding vehicle actually travels based on an expected driving trajectory, an error may occur in an actual driving trajectory of the surrounding vehicle due to the abnormality of the sensor unit 500. Second, the map information stored in the memory 620 and the state of a road on which the surrounding vehicle now travels may not be matched (e.g., the surrounding vehicles travel in a shifted lane because the lane has shifted to the left or right compared to the map information, stored in the memory 620, due to a construction or re-maintenance on a road on which the surrounding vehicle now travels). Accordingly, the processor 610 may perform the diagnosis of reliability of autonomous driving control over the ego vehicle based on the size of a trajectory error between the actual driving trajectory and expected driving trajectory of the surrounding vehicle or a cumulative addition of the trajectory errors. Furthermore, as described above, in order to take into consideration an overall driving tendency of the surrounding vehicle, trajectory errors between actual driving trajectories and expected driving trajectories of a plurality of surrounding vehicles, not an actual driving trajectory of any specific surrounding vehicle, may be taken into consideration.

A process of performing, by the processor 610, the diagnosis of reliability based on a trajectory error between an actual driving trajectory and expected driving trajectory of a surrounding vehicle is described in detail. First, when the state in which the size of a trajectory error is a preset first threshold value or more occurs within a preset first critical time, the processor 610 may determine that autonomous driving control over an ego vehicle is unreliable.

In this case, the first critical time means a time preset to diagnose the reliability of the autonomous driving control. Timing, that is, a criterion for the time, may be timing at which a comparison between an actual driving trajectory and expected driving trajectory of a surrounding vehicle is initiated by the processor 610. Specifically, a process of generating, by the processor 610, an actual driving trajectory and expected driving trajectory of a surrounding vehicle, calculating a trajectory error between the actual driving trajectory and the expected driving trajectory, and diagnosing the reliability of autonomous driving control may be periodically performed in a preset determination cycle in order to reduce the resource of the memory 620 and a computational load of the processor 610 (accordingly, an actual driving trajectory and expected driving trajectory of a surrounding vehicle stored in the memory 620 may be periodically deleted in the determination cycle). In this case, when the state in which the size of the trajectory error is the first threshold value or more occurs before the first critical time elapses from timing at which any one cycle was initiated, the processor 610 may determine that the autonomous driving control is unreliable. The size of the first critical time, which is a value smaller than the size of the temporal section of the determination cycle, may be variously designed depending on a designer's intention and stored in the memory 620. Furthermore, the first threshold value may be variously designed depending on a designer's intention and stored in the memory 620.

Furthermore, the processor 610 may additionally perform the diagnosis of reliability using the cumulative addition of the trajectory errors in the state in which the size of the trajectory error less than the first threshold value is maintained for the first critical time. That is, although the size of the trajectory error less than the first threshold value is maintained for the first critical time, when an accumulated and added value of the trajectory errors less than the first threshold value is a given value or more, the state of the surrounding vehicle corresponds to the state in which in spite of the small degree of error, the surrounding vehicle has traveled for a given time with deviating from the expected driving trajectory. Accordingly, the processor 610 can more precisely determine whether the autonomous driving control over the ego vehicle is reliable, by additionally performing the diagnosis of reliability using the cumulative addition of the trajectory errors.

In this case, in the state in which the size of the trajectory error less than the first threshold value maintained for the first critical time, when the state in which a cumulative addition of the trajectory errors (i.e., an accumulated and added value of the trajectory errors within one cycle) is a preset second threshold value or more occurs within a second critical time preset as a value greater than the first critical time, the processor 610 may determine that the autonomous driving control over the ego vehicle is unreliable. In this case, the second critical time, which is a value greater than the first critical time and smaller than the size of a temporal section of the determination cycle, may be previously stored in the memory 620. Furthermore, the second threshold value may be variously designed depending on a designer's intention and stored in the memory 620.

If it is determined that the autonomous driving control over the ego vehicle is unreliable through the aforementioned process, the processor 610 may output a warning to a passenger through the output unit 300 by taking into consideration a state of the passenger detected by (the internal camera sensor 535 of) the sensor unit 500 (i.e., a state of the passenger determined by the passenger state determination module 616). In this case, if it is determined that the passenger does not keep eyes forward, the processor 610 may output a warning to the passenger through the output unit 300. Accordingly, the passenger can take suitable follow-up measures by recognizing that there is a possibility that an operation of the sensor unit 500 is abnormal or there is a possibility that the map information stored in the memory 620 may be inaccurate, by recognizing the warning output through the output unit 300. As described above, the output unit 300 may include the speaker 310 and the display device 320. Accordingly, the warning output through the output unit 300 may be output in various ways, such as a voice warning through the speaker 310 or a visual warning through the display device 320. Furthermore, the warning may be implemented as the vibration of a seat depending on the specifications of a vehicle. That is, a method of outputting a warning is not limited to a specific embodiment within a range in which a passenger can currently recognize that autonomous driving control is unreliable. Furthermore, a method of outputting a warning through the output unit 300 may be configured or modified by a passenger based on a user interface (UI) provided by the user terminal 120 or a UI provided by the display device 320 itself.

After outputting the warning to the passenger through the output unit 300, when the size of the trajectory error becomes less than the first threshold value or the cumulative addition of the trajectory errors becomes less than the second threshold value, the processor 610 may release the warning output through the output unit 300. That is, after the warning is output, when the size of the trajectory error becomes less than the first threshold value or the cumulative addition of the trajectory errors becomes less than the second threshold value within any one cycle, this means that the reliability of the autonomous driving control over the ego vehicle has restored. Accordingly, the processor 610 can release the warning output through the output unit 300 in order to prevent an unnecessary warning from being output to a driver. In this case, if the warning has been output at specific timing although the warning output through the output unit 300 has been released, this means that there is a possibility that the map information stored in the memory 620 may be inaccurate in only a specific point or section in a road. Accordingly, the processor 610 may update map information, stored in the memory 620, with new map information subsequently received from the server 700 at timing at which current autonomous driving control over an ego vehicle is not affected.

Furthermore, after outputting the warning to the passenger through the output unit 300, if it is determined that a state of the passenger detected by the sensor unit 500 is a forward looking state, the processor 610 may release the warning output through the output unit 300. That is, if the passenger keeps eyes forward after the warning is output, it may be determined that the ego vehicle currently safely travels. Accordingly, the processor 610 can release the warning output through the output unit 300 to prevent an unnecessary warning from being output to a driver. In this case, the processor 610 may update map information, stored in the memory 620, with new map information subsequently received from the server 700 at timing at which current autonomous driving control over an ego vehicle is not affected.

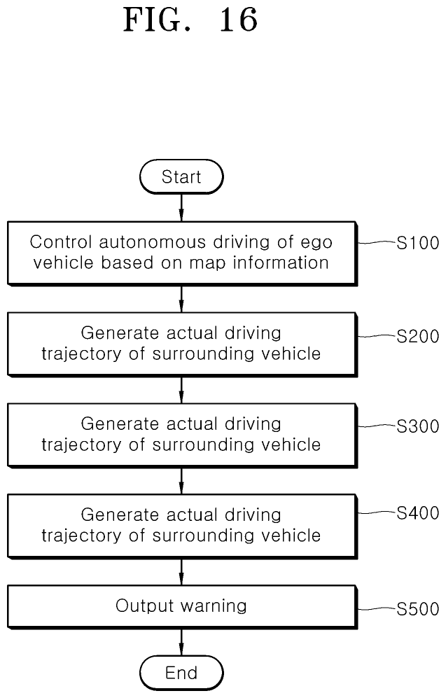

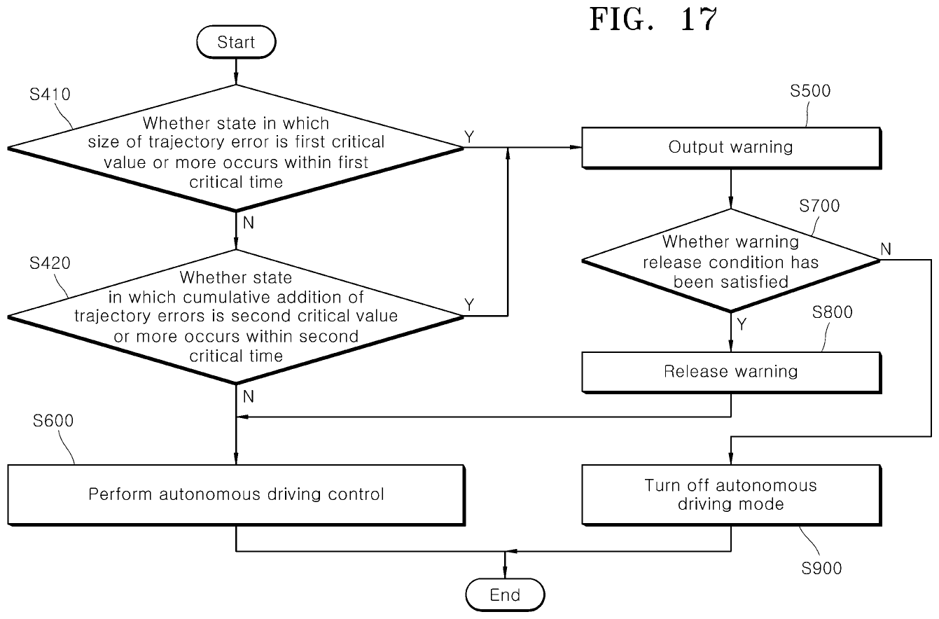

FIGS. 16 and 17 are flowcharts for describing an autonomous driving method according to the fifth exemplary embodiment of the present invention.

An autonomous driving method according to the fifth exemplary embodiment of the present invention is described with reference to FIG. 16. First, the processor 610 controls the autonomous driving of an ego vehicle based on the map information stored in the memory 620 (S100).

Thereafter, the processor 610 generates an actual driving trajectory of a surrounding vehicle based on driving information of the surrounding vehicle detected by the sensor unit 500 in a process in which the autonomous driving of the ego vehicle is performed (S200).

Next, the processor 610 generates an expected driving trajectory of the surrounding vehicle based on the map information stored in the memory 620 (S300).

Next, the processor 610 performs the diagnosis of reliability of autonomous driving control over the ego vehicle based on the size of a trajectory error between the actual driving trajectory and expected driving trajectory of the surrounding vehicle generated at steps S200 and S300 or a cumulative addition of the trajectory errors (S400).

If it is determined at step S400 that the autonomous driving control over the ego vehicle is unreliable, the processor 610 outputs a warning to a passenger through the output unit 300 by taking into consideration a state of the passenger detected by the sensor unit 500 (S500).

As illustrated in FIG. 17, at step S400, the processor 610 determines whether the state in which the size of the trajectory error is a preset first critical value or more occurs within a preset first critical time (S410).

If the size of the trajectory error less than the first critical value is maintained for the first critical time, the processor 610 determines whether the state in which a cumulative addition of the trajectory errors is a preset second critical value or more occurs within a second critical time preset as a value greater than the first critical time (S420).

If the state in which the size of the trajectory error is the first critical value or more occurs within the first critical time at step S410 or the state in which the cumulative addition of the trajectory errors is the second critical value or more occurs within the second critical time at step S420, the processor 610 determines that the autonomous driving control over the ego vehicle is unreliable, and performs step S500. If the size of the trajectory error less than the first critical value is maintained for the first critical time at step S410 and the state in which the cumulative addition of the trajectory errors is the second critical value or more does not occur within the second critical time at step S420, the processor 610 performs normal autonomous driving control (S600).

As illustrated in FIG. 17, after step S500, when the size of the trajectory error becomes less than the first critical value or the cumulative addition of the trajectory errors becomes less than the second critical value or if it is determined that a state of the passenger detected by the sensor unit 500 is a forward looking state (S700) (if the warning release condition of FIG. 16 is satisfied), the processor 610 releases the warning output through the output unit 300 (S800), and performs normal autonomous driving control (S600). In contrast, if it is determined that a state of the passenger detected by the sensor unit 500 does not correspond to a forward looking state in the state in which the size of the trajectory error maintains the first critical value or more or the cumulative addition of the trajectory errors maintains the second critical value or more (S700), the processor 610 turns off an autonomous driving mode (S900).

According to the fifth exemplary embodiment, the reliability of autonomous driving control is first diagnosed based on an error between an actual driving trajectory and expected driving trajectory of a surrounding vehicle around an autonomous vehicle. A warning is output to a passenger through an output device, such as a speaker or display device applied to the autonomous vehicle, by taking into consideration a state of the passenger, who has got in the autonomous vehicle, along with a result of the analysis. Accordingly, the driving stability and driving accuracy of the autonomous vehicle can be improved because the passenger can accurately recognize the autonomous driving state of the vehicle and take suitable follow-up measures.

It is to be noted that the steps included in the autonomous driving methods of the first to fifth exemplary embodiments are independent and are different steps although the same reference numerals (S000) have been used in the steps.

According to the first exemplary embodiment, the present invention can improve the autonomous driving stability of a vehicle and also enables follow-up measures suitable for a state of a passenger by controlling, depending on the states of a driver and fellow passenger, the autonomous driving of the vehicle by selectively applying a first expected driving trajectory based on a lane change rate predetermined based on a lane change pattern of the driver and information on the state of a road and a second expected driving trajectory based on a corrected lane change rate corrected from the lane change rate.

According to the second exemplary embodiment, the present invention can improve the driving stability and driving accuracy of an autonomous vehicle by learning an autonomous driving algorithm, applied to autonomous driving control, by taking into consideration driving manipulation of a passenger involved in an autonomous driving control process for an ego vehicle and then controlling the autonomous driving of the ego vehicle based on the autonomous driving algorithm whose learning has been completed.

According to the third exemplary embodiment, if a target point at which the driving direction of an ego vehicle is changed, such as a crossroad or junction, is present in the autonomous driving path of the ego vehicle, a trajectory up to the target point is modified based on a distance between a current location of the ego vehicle and the target point so that the ego vehicle reaches the target point through a step-by-step lane change. Accordingly, the present invention can secure the driving stability of the ego vehicle in a process of traveling based on the trajectory up to the target point. Furthermore, if the parking of an ego vehicle is performed, the present invention can improve parking convenience of a passenger by controlling the autonomous parking of the ego vehicle so that the ego vehicle can reach a parking location into which parking preference of the passenger has been incorporated.

According to the fourth exemplary embodiment, the present invention can improve the driving stability and driving accuracy of an autonomous vehicle, by determining a need to correct a driving trajectory of the autonomous vehicle and correcting the driving trajectory of the autonomous vehicle by taking into consideration a degree of risk based on a distance between the autonomous vehicle and a surrounding vehicle based on a result of the determination.

According to the fifth exemplary embodiment, the reliability of autonomous driving control is first diagnosed based on an error between an actual driving trajectory and expected driving trajectory of a surrounding vehicle around an autonomous vehicle. A warning is output to a passenger through an output device, such as a speaker or display device applied to the autonomous vehicle, by taking into consideration a state of the passenger, who has got in the autonomous vehicle, along with a result of the analysis. Accordingly, the present invention can improve the driving stability and driving accuracy of the autonomous vehicle because the passenger can accurately recognize the autonomous driving state of the vehicle and take suitable follow-up measures.

Although exemplary embodiments of the invention have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An autonomous driving apparatus comprising:
a sensor unit configured to detect a surrounding vehicle around an ego vehicle that autonomously travels and a state of a passenger who has got in the ego vehicle;
a driving information detector configured to detect driving information on a driving state of the ego vehicle;
a memory configured to store map information; and
a processor configured to control autonomous driving of the ego vehicle based on the map information stored in the memory,
wherein:
the memory stores a lane change pattern of a driver analyzed based on the driving information of the ego vehicle when the ego vehicle changes lanes, and a lane change rate determined based on information on a state of a road when the ego vehicle changes lanes and indicative of a tempo of the lane change of the ego vehicle;
the processor is configured to:
is control autonomous driving of the ego vehicle based on a first expected driving trajectory generated based on the map information and lane change rate stored in the memory and the driving information of the ego vehicle detected by the driving information detector; and
control the autonomous driving of the ego vehicle by selectively applying the first expected driving trajectory and a second expected driving trajectory based on the state of the passenger detected by the sensor unit; and
the second expected driving trajectory is generated by incorporating a corrected lane change rate corrected from the lane change rate stored in the memory.

2. The autonomous driving apparatus of claim 1, wherein:
the lane change rate is mapped to an entrance steering angle and entrance speed for entering a target lane when the ego vehicle changes lanes, and stored in the memory; and
the processor is configured to control the autonomous driving of the ego vehicle based on the entrance steering angle and entrance speed mapped to the lane change rate, when controlling the autonomous driving of the ego vehicle based on the first expected driving trajectory.

3. The autonomous driving apparatus of claim 2, wherein the processor is configured to control the autonomous driving of the ego vehicle based on an entrance steering angle and entrance speed having values greater than the entrance steering angle and entrance speed mapped to the lane change rate, when controlling the autonomous driving of the ego vehicle based on the second expected driving trajectory.

4. The autonomous driving apparatus of claim 3, wherein the processor is configured to control the autonomous driving of the ego vehicle based on the first expected driving trajectory when a driving concentration level of the driver determined based on the state of the driver detected by the sensor unit is equal to or greater than a preset critical concentration level, if a fellow passenger other than the driver has not entered the ego vehicle.

5. The autonomous driving apparatus of claim 3, wherein the processor is configured to control the autonomous driving of the ego vehicle based on the second expected driving trajectory, when it is determined that an emergency situation has occurred in the driver, based on the state of the driver detected by the sensor unit, if a fellow passenger other than the driver has not entered the ego vehicle.

6. The autonomous driving apparatus of claim 3, wherein the processor is configured to control the autonomous driving of the ego vehicle based on the second expected driving trajectory, if it is determined that an emergency situation has occurred in a fellow passenger, based on a state of the fellow passenger detected by the sensor unit, if the fellow passenger, in addition to the driver, has entered the ego vehicle.

7. The autonomous driving apparatus of claim 3, further comprising an output unit,
wherein the processor is configured to output a warning through the output unit either when a driving concentration level of the driver of the ego vehicle is less than a preset critical concentration level or when it is determined that an emergency situation has occurred in the driver or fellow passenger of the ego vehicle.

8. An autonomous driving method comprising:
a first control step of controlling, by a processor, autonomous driving of an ego vehicle based on a first expected driving trajectory generated based on map information and a lane change rate stored in a memory and driving information of the ego vehicle, wherein the lane change rate is determined based on a lane change pattern of a driver analyzed based on the driving information of the ego vehicle when the ego vehicle changes lanes and information on a state of a road when the ego vehicle changes lanes, and the lane change rate is indicative of a tempo of the lane change of the ego vehicle and stored in the memory; and
a second control step of controlling, by the processor, the autonomous driving of the ego vehicle by selectively applying the first expected driving trajectory and a second expected driving trajectory based on a state of a passenger detected by a sensor unit and getting in the ego vehicle, wherein the second expected driving trajectory is generated by incorporating a corrected lane change rate corrected from the lane change rate stored in the memory.

9. The autonomous driving method of claim 8, wherein:
the lane change rate is mapped to an entrance steering angle and entrance speed for entering a target lane when the ego vehicle changes lanes and stored in the memory; and
the processor controls the autonomous driving of the ego vehicle based on the entrance steering angle and entrance speed mapped to the lane change rate, when controlling the autonomous driving of the ego vehicle based on the first expected driving trajectory.

10. The autonomous driving method of claim 9, wherein the processor controls the autonomous driving of the ego vehicle based on an entrance steering angle and entrance speed having values greater than the entrance steering angle and entrance speed mapped to the lane change rate, when controlling the autonomous driving of the ego vehicle based on the second expected driving trajectory.

11. The autonomous driving method of claim 10, wherein in the second control step, the processor controls the autonomous driving of the ego vehicle based on the first expected driving trajectory, when a driving concentration level of the driver determined based on the state of the driver detected by the sensor unit is equal to or greater than a preset critical concentration level, if a fellow passenger other than the driver has not got in the ego vehicle.

12. The autonomous driving method of claim 10, wherein in the second control step, the processor controls the autonomous driving of the ego vehicle based on the second expected driving trajectory, if it is determined that an emergency situation has occurred in the driver based on the state of the driver detected by the sensor unit, if a fellow passenger other than the driver has not entered the ego vehicle.

13. The autonomous driving method of claim 10, wherein in the second control step, the processor controls the autonomous driving of the ego vehicle based on the second expected driving trajectory, if it is determined that an emergency situation has occurred in a fellow passenger based on a state of the fellow passenger detected by the sensor unit, if the fellow passenger in addition to the driver has entered the ego vehicle.

14. The autonomous driving method of claim 10, wherein in the second control step, the processor outputs a warning either when a driving concentration level of the driver of the ego vehicle is less than a preset critical concentration level or when it is determined that an emergency situation has occurred in the driver or fellow passenger of the ego vehicle.
